(19) United States
(12) Patent Application Publication
(10) Pub. No.: US 2025/0051524 A1
(43) Pub. Date: Feb. 13, 2025

(54) PREPARATION OF ORGANOSILICON COMPOUNDS WITH CARBOXY FUNCTIONALITY

(71) Applicants: Dow Silicones Corporation, Midland, MI (US); Dow Global Technologies LLC, Midland, MI (US)

(72) Inventors: Erich Molitor, Midland, MI (US); Jason Fisk, Midland, MI (US); Ryan Maar, Midland, MI (US); Robert Larsen, Midland, MI (US); David Devore, Midland, MI (US)

(21) Appl. No.: 18/715,165

(22) PCT Filed: Feb. 16, 2023
(86) PCT No.: PCT/US2023/062690

§ 371 Date: May 31, 2024

Related U.S. Application Data
(60) Provisional application No. 63/321,786, filed on Mar. 21, 2022.

(51) Int. Cl. C08G 77/04; C07F 7/08; C07F 7/21; C08G 77/00; C08G 77/08

(52) U.S. Cl. CPC C08G 77/045; C07F 7/0889; C07F 7/21; C08G 77/08; C08G 77/70

(57) ABSTRACT

An organosilicon compound with carboxy-functional groups is prepared. An oxidation process in which an aldehyde-functional organosilicon compound and an oxygen source are combined produces the carboxy-functional organosilicon compound.

### CROSS REFERENCE TO RELATED APPLICATIONS

This application claims the benefit of U.S. Provisional Patent Application Ser. No. 63/321,786 filed on 21 Mar. 2022 under 35 U.S.C. § 119 (e). U.S. Provisional Patent Application Ser. No. 63/321,786 is hereby incorporated by reference.

### FIELD

A process for preparing a carboxy-functional organosilicon compound is disclosed. The process for preparing the carboxy-functional organosilicon compound may employ hydroformylation of an alkenyl-functional organosilicon compound with carbon monoxide and hydrogen and subsequent oxidation.

### INTRODUCTION

Carboxy-functional organosilicon compounds (such as silanes and siloxanes) have been used in personal care markets and home care markets for applications such as emollients, moisturizers, carriers, laundry product additives, textile treatment product additives, surfactants, lubricants, and leather treatment product additives. However, the commercial availability of carboxy-functional organosilicon compounds has been limited due to challenging synthesis and high cost.

One approach to synthesizing carboxy-functional organosilicon compounds has been hydrosilylation of an acrylic acid or an acrylic ester with a silicon hydride (SiH). U.S. Pat. No. 2,589,445 to Sommer describes organosilicon carboxy acids and their production. A convenient method for the synthesis . . . is . . . the diethylester of malonic acid is reacted with sodium ethoxide in ethanol to produce the sodiomalonic ester. This material is then reacted with an alkyl halide (halogenoalkylsilane) . . . . The derivative so obtained is then saponified with an alkali metal hydroxide to obtain the disodium salt, which is then acidified to obtain the diacid, which when heated decarboxylates with the loss of one equivalent of carbon dioxide. By this method carboxy acids are obtained. U.S. Pat. No. 2,589,447 to Sommer describes the further conversion of a compound as described in U.S. Pat. No. 2,589,445 to produce a diacid disiloxane. However, these methods suffer from the drawback of inefficiency and/or production of relatively high amounts of side products.

Therefore, there is an unmet need in the organosilicon industry need for a relatively facile synthetic method to prepare carboxy-functional organosilicon compounds with various silane and siloxane architectures with relatively high purity, high selectivity, and/or low cost.

### SUMMARY

A process for preparing a carboxy-functional organosilicon compound comprises combining, under conditions to conduct oxidation reaction, starting materials comprising an aldehyde-functional organosilicon compound and an oxygen source, thereby forming an oxidation reaction product comprising the carboxy-functional organosilicon compound.

### DETAILED DESCRIPTION

### Aldehyde-functional Organosilicon Compound

Aldehyde-functional organosilicon compounds suitable for use in the process for preparing the carboxy-functional organosilicon compound are known and may be made by known methods, such as those described in U.S. Pat. No. 4,424,392 to Petty; U.S. Pat. No. 5,021,601 to Frances et al.; U.S. Pat. No. 5,739,246 to Graiver et al.; U.S. Pat. No. 7,696,294 to Asirvatham; and U.S. Pat. No. 7,999,053 to Sutton et al.; European Patent Application Publication EP 0 392 948 A1 to Frances; and PCT Patent Application Publication WO2006027074 to Kuhnle et al.

Alternatively, the aldehyde-functional organosilicon compound may be prepared by a hydroformylation process. This hydroformylation process comprises 1) combining, under conditions to catalyze hydroformylation reaction, starting materials comprising (A) a gas comprising hydrogen and carbon monoxide, (B) an alkenyl-functional organosilicon compound, and (C) hydroformylation reaction catalyst such as a rhodium/bisphosphite ligand complex catalyst, thereby forming a hydroformylation reaction product comprising the aldehyde-functional organosilicon compound.

The hydroformylation process described herein employs starting materials comprising: (A) a gas comprising hydrogen and carbon monoxide, (B) an alkenyl-functional organosilicon compound, and (C) a rhodium/bisphosphite ligand catalyst. The starting materials may optionally further comprise: (D) a solvent.

Starting material (A), the gas used in the hydroformylation process, comprises carbon monoxide (CO) and hydrogen gas (H₂). For example, the gas may be syngas. As used herein, “syngas” (from synthesis gas) refers to a gas mixture that contains varying amounts of CO and H₂. Production methods are well known and include, for example: (1) steam reforming and partial oxidation of natural gas or liquid hydrocarbons, and (2) the gasification of coal and/or biomass. CO and H₂ typically are the main components of syngas, but syngas may contain carbon dioxide and inert gases such as CH₄, N₂ and Ar. The molar ratio of H₂ to CO (H₂:CO molar ratio) varies greatly but may range from 1:100 to 100:1, alternatively 1:10 and 10:1. Syngas is commercially available and is often used as a fuel source or as an intermediate for the production of other chemicals. Alternatively, CO and H₂ from other sources (i.e., other than syngas) may be used as starting material (A) herein. Alternatively, the H₂:CO molar ratio in starting material (A) for use herein may be 3:1 to 1:3, alternatively 2:1 to 1:2, and alternatively 1:1.

The alkenyl-functional organosilicon compound has, per molecule, at least one alkenyl group covalently bonded to silicon. Alternatively, the alkenyl-functional organosilicon compound may have, per molecule, more than one alkenyl group covalently bonded to silicon. Starting material (B) may be one alkenyl-functional organosilicon compound. Alternatively, starting material (B) may comprise two or more alkenyl-functional organosilicon compounds that differ from one another. For example, the alkenyl-functional organosilicon compound may comprise one or both of (B1) a silane and (B2) a polyorganosiloxane.

Starting material (B1), the alkenyl-functional silane, may have formula (B1-1): R^{A}ₓSiR⁴₍₄₋ₓ₎, where each R^{A} is an independently selected alkenyl group of 2 to 8 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4. Alternatively, subscript x may be 1 or 2, alternatively 2, and alternatively 1. Alternatively, each R⁴ may be independently selected from the group consisting of an alkyl group of 1 to 18 carbon atoms, an aryl group of 6 to 18 carbon atoms, an acyloxy group of 1 to 18 carbon atoms, and a hydrocarbonoxy-functional group of 1 to 18 carbon atoms. Alternatively, each R⁴ may be independently selected from the group consisting of an alkyl group of 1 to 18 carbon atoms, an aryl group of 6 to 18 carbon atoms, and an alkoxy-functional group of 1 to 18 carbon atoms. Alternatively, each R⁴ in formula (B1-1) may be independently selected from the group consisting of an alkyl group of 1 to 18 carbon atoms, an aryl group of 6 to 18 carbon atoms, and a hydrocarbonoxy-functional group of 1 to 18 carbon atoms.

The alkenyl group for R^{A} may have terminal alkenyl functionality, e.g., R^{A} may have formula

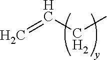

where subscript y is 0 to 6. Alternatively, each R^{A} may be independently selected from the group consisting of vinyl, allyl, and hexenyl. Alternatively, each R^{A} may be independently selected from the group consisting of vinyl and allyl. Alternatively, each R^{A} may be independently selected from the group consisting of vinyl and hexenyl. Alternatively, each R^{A} may be vinyl. Alternatively, each R^{A} may be allyl. Alternatively, each R^{A} may be hexenyl.

Suitable alkyl groups for R⁴ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Alternatively, the alkyl group for R⁴ may be selected from the group consisting of methyl, ethyl, propyl and butyl; alternatively methyl, ethyl, and propyl; alternatively methyl and ethyl. Alternatively, the alkyl group for R⁴ may be methyl.

Suitable aryl groups for R⁴ may be monocyclic or polycyclic and may have pendant hydrocarbyl groups. For example, the aryl groups for R⁴ include phenyl, tolyl, xylyl, and naphthyl and further include aralkyl groups such as benzyl, 1-phenylethyl and 2-phenylethyl. Alternatively, the aryl group for R⁴ may be monocyclic, such as phenyl, tolyl, or benzyl; alternatively the aryl group for R⁴ may be phenyl.

Suitable hydrocarbonoxy-functional groups for R⁴ may have the formula —OR⁵ or the formula —OR³—OR⁵, where each R³ is an independently selected divalent hydrocarbyl group of 1 to 18 carbon atoms, and each R⁵ is independently selected from the group consisting of the alkyl groups of 1-18 carbon atoms and the aryl groups of 6-18 carbon atoms, which are as described and exemplified above for R⁴. Examples of divalent hydrocarbyl groups for R³ include alkylene group such as ethylene, propylene, butylene, or hexylene; an arylene group such as phenylene, or an alkylarylene group such as:

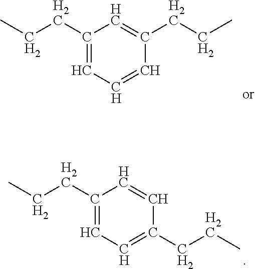

Alternatively, R³ may be an alkylene group such as ethylene. Alternatively, the hydrocarbonoxy-functional group may be an alkoxy-functional group such as methoxy, ethoxy, propoxy, or butoxy; alternatively methoxy or ethoxy, and alternatively methoxy.

Suitable acyloxy groups for R⁴ may have the formula

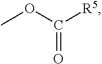

where R⁵ is as described above. Examples of suitable acyloxy groups include acetoxy. Alkenyl-functional acyloxysilanes and methods for their preparation are known in the art, for example, in U.S. Pat. No. 5,387,706 to Rasmussen, et al. and U.S. Pat. No. 5,902,892 to Larson, et al.

Suitable alkenyl-functional silanes are exemplified by alkenyl-functional trialkylsilanes such as vinyltrimethylsilane, vinyltriethylsilane, and allyltrimethylsilane; alkenyl-functional trialkoxysilanes such as allyltrimethoxysilane, vinyltrimethoxysilane, vinyltriethoxysilane, vinyltriisopropoxysilane, and vinyltris(methoxyethoxy)silane; alkenyl-functional dialkoxysilanes such as vinylphenyldiethoxysilane, vinylmethyldimethoxysilane, and vinylmethyldiethoxysilane; alkenyl-functional monoalkoxysilanes such as trivinylmethoxysilane; alkenyl-functional triacyloxysilanes such as vinyltriacetoxysilane, and alkenyl-functional diacyloxysilanes such as vinylmethyldiacetoxysilane. All of these alkenyl-functional silanes are commercially available from Gelest Inc. of Morrisville, Pennsylvania, USA. Furthermore, alkenyl-functional silanes may be prepared by known methods, such as those disclosed in U.S. Pat. No. 4,898,961 to Baile, et al. and U.S. Pat. No. 5,756,796 to Davern, et al.

Alternatively, (B) the alkenyl-functional organosilicon compound may comprise (B2) an alkenyl-functional polyorganosiloxane. Said polyorganosiloxane may be cyclic, linear, branched, resinous, or a combination of two or more thereof. Said polyorganosiloxane may comprise unit formula (B2-1): (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(SiO_{4/2})_{g}(ZO_{1/2})ₕ; where R^{A} and R⁴ are as described above; each Z is independently selected from the group consisting of a hydrogen atom and R⁵ (where R⁵ is as described above), subscripts a, b, c, d, e, f, and g represent numbers of each unit in formula (B2-1) and have values such that subscript a≥0, subscript b≥0, subscript c≥0, subscript d≥0, subscript e≥0, subscript f≥0, and subscript g≥0; a quantity (a+b+c+d+e+f+g)≥2, and a quantity (b+d+f)≥1, and subscript h has a value such that 0≤h/(e+f+g)≤1.5. When e=f=g=0, then h≥0. At the same time, the quantity (a+b+c+d+e+f+g) may be ≤10,000. Alternatively, in formula (B-2-1), each R⁴ may be independently selected from the group consisting of a hydrogen atom, an alkyl group of 1 to 18 carbon atoms, an aryl group of 6 to 18 carbon atoms, and a hydrocarbonoxy-functional group of 1 to 18 carbon atoms. Alternatively, each R⁴ may be independently selected from the group consisting of an alkyl group of 1 to 18 carbon atoms, an aryl group of 6 to 18 carbon atoms, and an alkoxy-functional group of 1 to 18 carbon atoms. Alternatively, each R⁴ may be independently selected from the group consisting of an alkyl group of 1 to 18 carbon atoms and an aryl group of 6 to 18 carbon atoms. Alternatively, each Z may be hydrogen or an alkyl group of 1 to 6 carbon atoms. Alternatively, each Z may be hydrogen.

Alternatively, (B2) the alkenyl-functional polyorganosiloxane may comprise (B2-2) a linear polydiorganosiloxane having, per molecule, at least one alkenyl group; alternatively at least two alkenyl groups (e.g., when in formula (B2-1) above, subscripts e=f=g=0). For example, said polydiorganosiloxane may comprise unit formula (B2-3): (R⁴₃SiO_{1/2})ₐ(R^{A}R⁴₂SiO_{1/2})_{b}(R⁴₂SiO_{2/2})_{c}(R^{A}R⁴SiO_{2/2})ₐ, where R^{A} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2.

Alternatively, in unit formula (B2-3) the quantity (a+b+c+d) may be at least 3, alternatively at least 4, and alternatively>50. At the same time in unit formula (B2-3), the quantity (a+b+c+d) may be less than or equal to 10,000; alternatively less than or equal to 4,000; alternatively less than or equal to 2,000; alternatively less than or equal to 1,000; alternatively less than or equal to 500; alternatively less than or equal to 250. Alternatively, in unit formula (B2-3) each R⁴ may be independently selected from the group consisting of alkyl and aryl; alternatively methyl and phenyl. Alternatively, each R⁴ in unit formula (B2-3) may be an alkyl group; alternatively each R⁴ may be methyl.

Alternatively, the polydiorganosiloxane of unit formula (B2-3) may be selected from the group consisting of: unit formula (B2-4): (R⁴₂R^{A}SiO_{1/2})₂(R⁴₂SiO_{2/2})ₘ(R⁴R^{A}SiO_{2/2})ₙ, unit formula (B2-5): (R⁴₃SiO_{1/2})₂(R⁴₂SiO_{2/2})ₒ(R⁴R^{A}SiO_{2/2})ₚ, or a combination of both (B2-4) and (B2-5).

In formulae (B2-4) and (B2-5), each R⁴ and R^{A} are as described above. Subscript m may be 0 or a positive number. Alternatively, subscript m may be at least 2. Alternatively subscript m be 2 to 2,000. Subscript n may be 0 or a positive number. Alternatively, subscript n may be 0 to 2000. Subscript o may be 0 or a positive number. Alternatively, subscript o may be 0 to 2000. Subscript p is at least 2. Alternatively subscript p may be 2 to 2000.

Starting material (B2) may comprise an alkenyl-functional polydiorganosiloxane such as i) bis-dimethylvinylsiloxy-terminated polydimethylsiloxane, ii) bis-dimethylvinylsiloxy-terminated poly(dimethylsiloxane/methylvinylsiloxane), iii) bis-dimethylvinylsiloxy-terminated polymethylvinylsiloxane, iv) bis-trimethylsiloxy-terminated poly(dimethylsiloxane/methylvinylsiloxane), v) bis-trimethylsiloxy-terminated polymethylvinylsiloxane, vi) bis-dimethylvinylsiloxy-terminated poly(dimethylsiloxane/methylphenylsiloxane/methylvinylsiloxane), vii) bis-dimethylvinylsiloxy-terminated poly(dimethylsiloxane/methylphenylsiloxane), viii) bis-dimethylvinylsiloxy-terminated poly(dimethylsiloxane/diphenylsiloxane), ix) bis-phenyl,methyl,vinyl-siloxy-terminated polydimethylsiloxane, x) bis-dimethylhexenylsiloxy-terminated polydimethylsiloxane, xi) bis-dimethylhexenylsiloxy-terminated poly(dimethylsiloxane/methylhexenylsiloxane), xii) bis-dimethylhexenylsiloxy-terminated polymethylhexenylsiloxane, xiii) bis-trimethylsiloxy-terminated poly(dimethylsiloxane/methylhexenylsiloxane), xiv) bis-trimethylsiloxy-terminated polymethylhexenylsiloxane, xv) bis-dimethylhexenyl-siloxy terminated poly(dimethylsiloxane/methylphenylsiloxane/methylhexenylsiloxane), xvi) bis-dimethylvinylsiloxy-terminated poly(dimethylsiloxane/methylhexenylsiloxane), xvii) bis-dimethylhexenyl-siloxy-terminated poly(dimethylsiloxane/methylphenylsiloxane), xviii) dimethylhexenyl-siloxy-terminated poly(dimethylsiloxane/diphenylsiloxane), and xix) a combination of two or more of i) to xviii).

Methods of preparing linear alkenyl-functional polydiorganosiloxanes described above for starting material (B2), such as hydrolysis and condensation of the corresponding organohalosilanes and oligomers or equilibration of cyclic polydiorganosiloxanes, are known in the art, see for example U.S. Pat. Nos. 3,284,406; 4,772,515; 5,169,920; 5,317,072; and 6,956,087, which disclose preparing linear polydiorganosiloxanes with alkenyl groups. Examples of linear polydiorganosiloxanes having alkenyl groups are commercially available from, e.g., Gelest Inc. of Morrisville, Pennsylvania, USA under the tradenames DMS-V00, DMS-V03, DMS-V05, DMS-V21, DMS-V22, DMS-V25, DMS-V-31, DMS-V33, DMS-V34, DMS-V35, DMS-V41, DMS-V42, DMS-V43, DMS-V46, DMS-V51, DMS-V52.

Alternatively, (B2) the alkenyl-functional polyorganosiloxane may be cyclic, e.g., when in unit formula (B2-1), subscripts a=b=c=e=f=g=h=0. The cyclic alkenyl-functional polydiorganosiloxane may have unit formula (B2-7): (R⁴R^{A}SiO_{2/2})_{d}, where R^{A} and R⁴ are as described above, and subscript d may be 3 to 12, alternatively 3 to 6, and alternatively 4 to 5. Examples of cyclic alkenyl-functional polydiorganosiloxanes include 2,4,6-trimethyl-2,4,6-trivinyl-cyclotrisiloxane, 2,4,6,8-tetramethyl-2,4,6,8-tetravinyl-cyclotetrasiloxane, 2,4,6,8,10-pentamethyl-2,4,6,8,10-pentavinyl-cyclopentasiloxane, and 2,4,6,8,10,12-hexamethyl-2,4,6,8,10,12-hexavinyl-cyclohexasiloxane. These cyclic alkenyl-functional polydiorganosiloxanes are known in the art and are commercially available from, e.g., Sigma-Aldrich of St. Louis, Missouri, USA; Milliken of Spartanburg, South Carolina, USA; and other vendors.

Alternatively, the cyclic alkenyl-functional polydiorganosiloxane may have unit formula (B2-8): (R⁴₂SiO_{2/2})_{c}(R⁴R^{A}SiO_{2/2})_{d}, where R⁴ and R^{A} are as described above, subscript c is >0 to 6 and subscript d is 3 to 12. Alternatively, in formula (B2-8), c may be 3 to 6, and d may be 3 to 6.

Alternatively, (B2) the alkenyl-functional polyorganosiloxane may be oligomeric, e.g., when in unit formula (B2-1) above the quantity (a+b+c+d+e+f+g)≤50, alternatively≤40, alternatively≤30, alternatively≤25, alternatively≤20, alternatively≤10, alternatively≤5, alternatively≤4, alternatively≤3. The oligomer may be cyclic, linear, branched, or a combination thereof. The cyclic oligomers are as described above as starting material (B2-6).

Examples of linear alkenyl-functional polyorganosiloxane oligomers may have formula (B2-10):

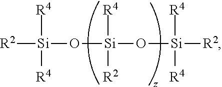

where R⁴ is as described above, each R² is independently selected from the group consisting of R⁴ and R^{A}, with the proviso that at least one R², per molecule, is R^{A}, and subscript z is 0 to 48. Examples of linear alkenyl-functional polyorganosiloxane oligomers may have include 1,3-divinyl-1,1,3,3-tetramethyldisiloxane; 1,1,1,3,3-pentamethyl-3-vinyl-disiloxane; 1,1,1,3,5,5,5-heptamethyl-3-vinyl-trisiloxane, all of which are commercially available, e.g., from Gelest, Inc. of Morrisville, Pennsylvania, USA or Sigma-Aldrich of St. Louis, Missouri, USA.

Alternatively, the alkenyl-functional polyorganosiloxane oligomer may be branched. The branched oligomer may have general formula (B2-11): R^{A}SiR¹²₃, where R^{A} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (B2-11) when each R¹² is —OSi(R¹⁴)₃, each R¹⁴ may be —OSi(R¹⁵)₃ moieties such that the branched polyorganosiloxane oligomer has the following structure:

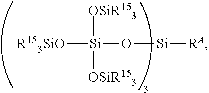

where R^{A} and R¹⁵ are as described above. Alternatively, each R¹⁵ may be an R¹³, as described above, and each R¹³ may be methyl.

Alternatively, in formula (B2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched polyorganosiloxane oligomer has the following structure:

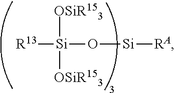

where R^{A}, R¹³, and R¹⁵ are as described above. Alternatively, each R¹⁵ may be an R¹³, and each R¹³ may be methyl.

Alternatively, in formula (B2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of R¹² are —OSiR¹³(R¹⁴)₂. Alternatively, each R¹⁴ in —OSiR¹³(R¹⁴)₂ may be —OSi(R¹⁵)₃ such that the branched polyorganosiloxane oligomer has the following structure:

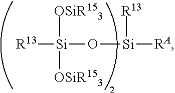

where R^{A}, R¹³, and R¹⁵ are as described above. Alternatively, each R¹⁵ may be an R¹³, and each R¹³ may be methyl. Alternatively, the alkenyl-functional branched polyorganosiloxane may have 3 to 16 silicon atoms per molecule, alternatively 4 to 16 silicon atoms per molecule, and alternatively 4 to 10 silicon atoms per molecule. Examples of alkenyl-functional branched polyorganosiloxane oligomers include vinyl-tris(trimethyl)siloxy)silane, which has formula:

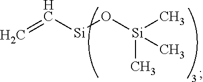

methyl-vinyl-di((1,1,1,3,5,5,5-heptamethyltrisiloxan-3-yl)oxy)-silane, which has formula

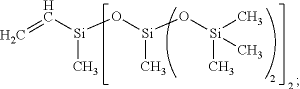

vinyl-tris((1,1,1,3,5,5,5-heptamethyltrisiloxan-3-yl)oxy)-silane, which has formula

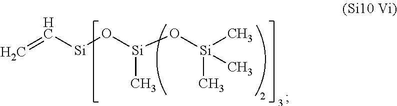

and (hex-5-en-1-yl)-tris((1,1,1,3,5,5,5-heptamethyltrisiloxan-3-yl)oxy)-silane, which has formula

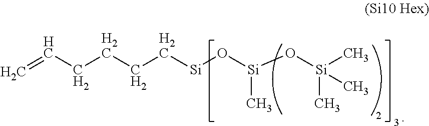

Branched alkenyl-functional polyorganosiloxane oligomers described above may be prepared by known methods, such as those disclosed in “Testing the Functional Tolerance of the Piers-Rubinsztajn Reaction: A new Strategy for Functional Silicones” by Grande, et al. Supplementary Material (ESI) for Chemical Communications, © The Royal Society of Chemistry 2010.

Alternatively, (B2) the alkenyl-functional polyorganosiloxane may be branched, such as the branched oligomer described above and/or a branched alkenyl-functional polyorganosiloxane that may have, e.g., more alkenyl groups per molecule and/or more polymer units than the branched oligomer described above (e.g., in formula (B2-1) when the quantity (a+b+c+d+e+f+g)>50). The branched alkenyl-functional polyorganosiloxane may have (in formula (B2-1)) a quantity (e+f+g) sufficient to provide>0 to 5 mol % of trifunctional and/or quadrifunctional units to the branched alkenyl-functional polyorganosiloxane.

For example, the branched alkenyl-functional polyorganosiloxane may comprise a Q branched polyorganosiloxane of unit formula (B2-13): (R⁴₃SiO_{1/2})_{q}(R⁴₂R^{A}SiO_{1/2})ᵣ(R⁴₂SiO_{2/2})ₛ(SiO_{4/2})ₜ, where R⁴ and R^{A} are as described above, and subscripts q, r, s, and t have average values such that 2≥q≥0, 4≥r≥0, 995≥s≥4, t=1, (q+r)=4, and (q+r+s+t) has a value sufficient to impart a viscosity>170 mPa·s measured by rotational viscometry (as described below with the test methods) to the branched polyorganosiloxane. Alternatively, viscosity may be >170 mPa·s to 1000 mPa·s, alternatively>170 to 500 mPa·s, alternatively 180 mPa·s to 450 mPa·s, and alternatively 190 mPa·s to 420 mPa·s. Suitable Q branched polyorganosiloxanes for starting material (B2-12) are known in the art and can be made by known methods, exemplified by those disclosed in U.S. Pat. No. 6,806,339 to Cray, et al. and U.S. Patent Publication 2007/0289495 to Cray, et al.

Alternatively, the branched alkenyl-functional polyorganosiloxane may comprise formula (B2-14): [R^{A}R⁴₂Si—(O—SiR⁴₂)ₓ—O]_{(4-W)}—Si—[O—(R⁴₂SiO)ᵥSiR⁴₃]_{w}, where R^{A} and R⁴ are as described above; and subscripts v, w, and x have values such that 200≥v≥1, 2≥w≥0, and 200≥x≥1. Alternatively, in this formula (B2-14), each R⁴ is independently selected from the group consisting of methyl and phenyl, and each R^{A} is independently selected from the group consisting of vinyl, allyl, and hexenyl. Branched polyorganosiloxane suitable for starting material (B2-14) may be prepared by known methods such as heating a mixture comprising a polyorganosilicate resin, and a cyclic polydiorganosiloxane or a linear polydiorganosiloxane, in the presence of a catalyst, such as an acid or phosphazene base, and thereafter neutralizing the catalyst.

Alternatively, the branched alkenyl-functional polyorganosiloxane for starting material (B2-11) may comprise a T branched polyorganosiloxane (silsesquioxane) of unit formula (B2-15): (R⁴₃SiO_{1/2})ₐₐ(R^{A}R⁴₂SiO_{1/2})_{bb}(R⁴₂SiO_{2/2})_{cc}(R^{A}R⁴SiO_{2/2})ₑₑ(R⁴SiO_{3/2})_{dd}, where R⁴ and R^{A} are as described above, subscript aa≥0, subscript bb>0, subscript cc is 15 to 995, subscript dd≥0, and subscript ee≥0. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb≥0; alternatively 12≥bb≥3; alternatively 10≥bb≥0; alternatively 7≥bb≥1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may be 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd>0; alternatively 5≥dd>0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (B2-15) with an alkenyl content of 0.1% to 1%, alternatively 0.2% to 0.6%, based on the weight of the silsesquioxane. Suitable T branched polyorganosiloxanes (silsesquioxanes) for starting material (B2-15) are exemplified by those disclosed in U.S. Pat. No. 4,374,967 to Brown, et al; U.S. Pat. No. 6,001,943 to Enami, et al.; U.S. Pat. No. 8,546,508 to Nabeta, et al.; and U.S. Pat. No. 10,155,852 to Enami.

Alternatively, (B2) the alkenyl-functional polyorganosiloxane may comprise an alkenyl-functional polyorganosilicate resin, which comprises monofunctional units (“M” units) of formula R^{M}₃SiO_{1/2} and tetrafunctional silicate units (“Q” units) of formula SiO_{4/2}, where each R^{M} is an independently selected monovalent hydrocarbon group; each R^{M} may be independently selected from the group consisting of R⁴ and R^{A} as described above. Alternatively, each R^{M} may be selected from the group consisting of alkyl, alkenyl and aryl. Alternatively, each R^{M} may be selected from methyl, vinyl and phenyl. Alternatively, at least one-third, alternatively at least two thirds of the R^{M} groups are methyl groups. Alternatively, the M units may be exemplified by (Me₃SiO_{1/2}), (Me₂PhSiO_{1/2}), and (Me₂ViSiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M}₃)₄, where R^{M} is as described above, e.g., the neopentamer may be tetrakis(trimethylsiloxy)silane. ²⁹Si NMR and ¹³C NMR spectroscopies may be used to measure hydroxyl and alkoxy content and molar ratio of M and Q units, where said ratio is expressed as {M(resin)}/{Q(resin)}, excluding M and Q units from the neopentamer. M/Q ratio represents the molar ratio of the total number of triorganosiloxy groups (M units) of the resinous portion of the polyorganosilicate resin to the total number of silicate groups (Q units) in the resinous portion. M/Q ratio may be 0.5/1 to 1.5/1, alternatively 0.6/1 to 0.9/1.

The Mn of the polyorganosilicate resin depends on various factors including the types of hydrocarbon groups represented by R^{M} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da; alternatively 1,500 Da to 15,000 Da; alternatively>3,000 Da to 8,000 Da. Alternatively, Mn of the polyorganosilicate resin may be 3,500 Da to 8,000 Da.

U.S. Pat. No. 8,580,073 at col. 3, line 5 to col. 4, line 31, and U.S. Patent Publication 2016/0376482 at paragraphs [0023] to [0026] are hereby incorporated by reference for disclosing MQ resins, which are suitable polyorganosilicate resins for use as starting material (B2). The polyorganosilicate resin can be prepared by any suitable method, such as cohydrolysis of the corresponding silanes or by silica hydrosol capping methods. The polyorganosilicate resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M units and Q units. The resulting copolymers generally contain from 2 to 5 percent by weight of hydroxyl groups.

The intermediates used to prepare the polyorganosilicate resin may be triorganosilanes and silanes with four hydrolyzable substituents or alkali metal silicates. The triorganosilanes may have formula R^{M}₃SiX, where R^{M} is as described above and X represents a hydroxyl group or a hydrolyzable substituent, e.g., of formula OZ described above. Silanes with four hydrolyzable substituents may have formula SiX²₄, where each X² is independently selected from the group consisting of halogen, alkoxy, and hydroxyl. Suitable alkali metal silicates include sodium silicate.

The polyorganosilicate resin prepared as described above typically contain silicon bonded hydroxyl groups, e.g., of formula, HOSiO_{3/2}. The polyorganosilicate resin may comprise up to 3.5% of silicon bonded hydroxyl groups, as measured by FTIR spectroscopy and/or NMR spectroscopy, as described above. For certain applications, it may desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the polyorganosilicate resin can be converted to trihydrocarbon siloxane groups or to a different hydrolyzable group by reacting the silicone resin with a silane, disiloxane, or disilazane containing the appropriate terminal group. Silanes containing hydrolyzable groups may be added in molar excess of the quantity required to react with the silicon bonded hydroxyl groups on the polyorganosilicate resin.

Alternatively, the polyorganosilicate resin may further comprise 2% or less, alternatively 0.7% or less, and alternatively 0.3% or less, and alternatively 0.3% to 0.8% of units containing hydroxyl groups, e.g., those represented by formula XSiO_{3/2} where R^{M} is as described above, and X represents a hydrolyzable substituent, e.g., OH. The concentration of silanol groups (where X═OH) present in the polyorganosilicate resin may be determined using FTIR spectroscopy and/or NMR as described above.

For use herein, the polyorganosilicate resin further comprises one or more terminal alkenyl groups per molecule. The polyorganosilicate resin having terminal alkenyl groups may be prepared by reacting the product of Daudt, et al. with an alkenyl group-containing endblocking agent and an endblocking agent free of aliphatic unsaturation, in an amount sufficient to provide from 3 to 30 mole percent of alkenyl groups in the final product. Examples of endblocking agents include, but are not limited to, silazanes, siloxanes, and silanes. Suitable endblocking agents are known in the art and exemplified in U.S. Pat. No. 4,584,355 to Blizzard, et al.; U.S. Pat. No. 4,591,622 to Blizzard, et al.; and U.S. Pat. No. 4,585,836 Homan, et al. A single endblocking agent or a mixture of such agents may be used to prepare such resin.

Alternatively, the polyorganosilicate resin may comprise unit formula (B2-17): (R⁴₃SiO_{1/2})ₘₘ(R⁴₂R^{A}SiO_{1/2})ₙₙ(SiO_{4/2})ₒₒ(ZO_{1/2})ₕ, where Z, R⁴, and R^{A}, and subscript h are as described above and subscripts mm, nn and oo have average values such that mm≥0, nn>0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/oo≤4.

Alternatively, (B2) the alkenyl-functional polyorganosiloxane may comprise (B2-18) an alkenyl-functional silsesquioxane resin, i.e., a resin containing trifunctional (T) units of unit formula: (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(ZO_{1/2})ₕ; where R⁴ and R^{A} are as described above, subscript f>1, 2<(e+f)<10,000; 0<(a+b)/(e+f)<3; 0<(c+d)/(e+f)<3; and 0<h/(e+f)<1.5. Alternatively, the alkenyl-functional silsesquioxane resin may comprise unit formula (B2-19): (R⁴SiO_{3/2})ₑ(R^{A}SiO_{3/2})_{f}(ZO_{1/2})ₕ, where R⁴, R^{A}, Z, and subscripts h, e and f are as described above. Alternatively, the alkenyl-functional silsesquioxane resin may further comprise difunctional (D) units of formulae (R⁴₂SiO_{2/2})_{c}(R⁴R^{A}SiO_{2/2})_{d} in addition to the T units described above, i.e., a DT resin, where subscripts c and d are as described above. Alternatively, the alkenyl-functional silsesquioxane resin may further comprise monofunctional (M) units of formulae (R⁴₃SiO_{1/2})ₐ(R⁴₂R^{A}SiO_{1/2})_{b}, i.e., an MDT resin, where subscripts a and b are as described above for unit formula (B2-1).

Alkenyl-functional silsesquioxane resins are commercially available, for example. RMS-310, which comprises unit formula (B2-20): (Me₂ViSiO_{1/2})₂₅(PhSiO_{3/2})₇₅ dissolved in toluene, is commercially available from Dow Silicones Corporation of Midland, Michigan, USA. Alkenyl-functional silsesquioxane resins may be produced by the hydrolysis and condensation or a mixture of trialkoxy silanes using the methods as set forth in “Chemistry and Technology of Silicone” by Noll, Academic Press, 1968, chapter 5, p 190-245. Alternatively, alkenyl-functional silsesquioxane resins may be produced by the hydrolysis and condensation of a trichlorosilane using the methods as set forth in U.S. Pat. No. 6,281,285 to Becker, et al. and U.S. Pat. No. 5,010,159 to Bank, et al. Alkenyl-functional silsesquioxane resins comprising D units may be prepared by known methods, such as those disclosed in U.S. Patent Application 2020/0140619 to Swier, et al. and PCT Publication WO2018/204068 to Swier, et al.

Starting material (B) may be any one of the alkenyl-functional organosilicon compounds described above. Alternatively, starting material (B) may comprise a mixture of two or more of the alkenyl-functional organosilicon compounds.

Starting material (C), the hydroformylation reaction catalyst for use herein comprises an activated complex of rhodium and a close ended bisphosphite ligand. The bisphosphite ligand may be symmetric or asymmetric. Alternatively, the bisphosphite ligand may be symmetric. The bisphosphite ligand may have formula (C1):

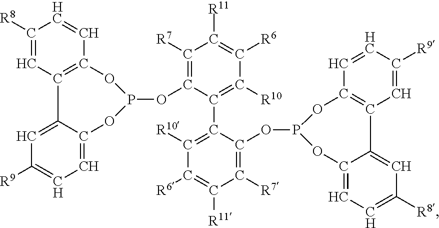

where R⁶ and R^{6′} are each independently selected from the group consisting of hydrogen, an alkyl group of at least one carbon atom, a cyano group, a halogen group, and an alkoxy group of at least one carbon atom; R⁷ and R^{7′} are each independently selected from the group consisting of an alkyl group of at least 3 carbon atoms and a group of formula —SiR¹⁷₃, where each R¹⁷ is an independently selected monovalent hydrocarbon group of 1 to 20 carbon atoms; R⁸, R^{8′}, R⁹, and R^{9′} are each independently selected from the group consisting of hydrogen, an alkyl group, a cyano group, a halogen group, and an alkoxy group; and R¹⁰, R^{10′}, R¹¹, and R^{11′} are each independently selected from the group consisting of hydrogen and an alkyl group. Alternatively, one of R⁷ and R^{7′} may be hydrogen.

In formula (C1), R⁶ and R^{6′} may be alkyl groups of least one carbon atom, alternatively 1 to 20 carbon atoms. Suitable alkyl groups for R⁶ and R^{6′} may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁶ and R^{6′} may be selected from the group consisting of ethyl, propyl and butyl; alternatively propyl and butyl. Alternatively, the alkyl group for R⁶ and R^{6′} may be butyl. Alternatively, R⁶ and R^{6′} may be alkoxy groups, wherein the alkoxy group may have formula —OR^{6″}, where R^{6″} is an alkyl group as described above for R⁶ and R^{6′}.

Alternatively, in formula (C1), R⁶ and R^{6′} may be independently selected from alkyl groups of 1 to 6 carbon atoms and alkoxy groups of 1 to 6 carbon atoms. Alternatively, R⁶ and R^{6′} may be alkyl groups of 2 to 4 carbon atoms. Alternatively, R⁶ and R^{6′} may be alkoxy groups of 1 to 4 carbon atoms. Alternatively, R⁶ and R^{6′} may be butyl groups, alternatively tert-butyl groups. Alternatively, R⁶ and R^{6′} may be methoxy groups.

In formula (C1), R⁷ and R^{7′} may be alkyl groups of least three carbon atoms, alternatively 3 to 20 carbon atoms. Suitable alkyl groups for R⁷ and R^{7′} may be linear, branched, cyclic, or combinations of two or more thereof. The alkyl groups are exemplified by propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 20 carbon atoms), and the alkyl groups are further exemplified by cycloalkyl groups such as cyclopropyl, cyclobutyl, cyclopentyl, and cyclohexyl. Alternatively, the alkyl group for R⁷ and R^{7′} may be selected from the group consisting of propyl and butyl. Alternatively, the alkyl group for R⁷ and R^{7′} may be butyl.

Alternatively, in formula (C1), R⁷ and R^{7′} may be a silyl group of formula —SiR¹⁷₃, where each R¹⁷ is an independently selected monovalent hydrocarbon group of 1 to 20 carbon atoms. The monovalent hydrocarbon group may be an alkyl group of 1 to 20 carbon atoms, as described above for R⁶ and R^{6′}.

Alternatively, in formula (C1), R⁷ and R^{7′} may each be independently selected alkyl groups, alternatively alkyl groups of 3 to 6 carbon atoms. Alternatively, R⁷ and R^{7′} may be alkyl groups of 3 to 4 carbon atoms. Alternatively, R⁷ and R^{7′} may be butyl groups, alternatively tert-butyl groups.

In formula (C1), R⁸, R^{8′}, R⁹, R^{9′} may be alkyl groups of at least one carbon atom, as described above for R⁶ and R^{6′}. Alternatively, R⁸ and R^{8′} may be independently selected from the group consisting of hydrogen and alkyl groups of 1 to 6 carbon atoms. Alternatively, R⁸ and R^{8′} may be hydrogen. Alternatively, in formula (C1), R^{9,} and R^{9′} may be independently selected from the group consisting of hydrogen and alkyl groups of 1 to 6 carbon atoms. Alternatively, R⁹ and R^{9′} may be hydrogen.

In formula (C1), R¹⁰ and R^{10′} may be hydrogen atoms or alkyl groups of least one carbon atom, alternatively 1 to 20 carbon atoms. The alkyl groups for R¹⁰ and R^{10′} may be as described above for R⁶ and R^{6′}. Alternatively, R¹⁰ and R^{10′} may be methyl. Alternatively, R¹⁰ and R^{10′} may be hydrogen.

In formula (C1), R¹¹ and R^{11′} may be hydrogen atoms or alkyl groups of least one carbon atom, alternatively 1 to 20 carbon atoms. The alkyl groups for R¹¹ and R^{11′} may be as described above for R⁶ and R^{6′}′. Alternatively, R¹¹ and R^{11′ ′} may be hydrogen.

Alternatively, the ligand of formula (C1) may be selected from the group consisting of (C1-1) 6,6′-[[3,3′,5,5′-tetrakis(1,1-dimethylethyl)-1,1′-biphenyl]-2,2′-diyl]bis(oxy)]bis-dibenzo[d,f] [1,3,2]dioxaphosphepin; (C1-2) 6,6′-[(3,3′-di-tert-butyl-5,5′-dimethoxy-1,1′-biphenyl-2,2′-diyl)bis(oxy)]bis(dibenzo[d/f][1,3,2]dioxaphosphepin); and a combination of both (C1-1) and (C1-2).

Alternatively, the ligand may comprise 6,6′-[[3,3′,5,5′-tetrakis(1,1-dimethylethyl)-1,1′-biphenyl]-2,2′-diyl]bis(oxy)]bis-dibenzo[d,f] [1,3,2]dioxaphosphepin, as disclosed at col. 11 of U.S. Pat. No. 10,023,516 (see also U.S. Pat. No. 7,446,231, which discloses this compound as Ligand D at col. 22 and U.S. Pat. No. 5,727,893 at col. 20, lines 40-60 as ligand F).

Alternatively, the ligand may comprise biphephos, which is commercially available from Sigma Aldrich and may be prepared as described in U.S. Pat. No. 9,127,030. (See also U.S. Pat. No. 7,446,231 ligand B at col. 21 and U.S. Pat. No. 5,727,893 at col. 20, lines 5-18 as ligand D).

Starting material (C), the rhodium/bisphosphite ligand complex catalyst, may be prepared by methods known in the art, such as those disclosed in U.S. Pat. No. 4,769,498 to Billig, et al. at col. 20, line 50-col. 21, line 40 and U.S. Pat. No. 10,023,516 to Brammer et al. col. 11, line 35-col. 12, line 12 by varying appropriate starting materials. For example, the rhodium/bisphosphite ligand complex may be prepared by a process comprising combining a rhodium precursor and the bisphosphite ligand (C1) described above under conditions to form the complex, which complex may then be introduced into a hydroformylation reaction medium comprising one or both of starting materials (A) and/or (B), described above. Alternatively, the rhodium/bisphosphite ligand complex may be formed in situ by introducing the rhodium catalyst precursor into the reaction medium, and introducing (C1) the bisphosphite ligand into the reaction medium (e.g., before, during, and/or after introduction of the rhodium catalyst precursor), for the in situ formation of the rhodium/bisphosphite ligand complex. The rhodium/bisphosphite ligand complex can be activated by heating and/or exposure to starting material (A) to form the (C) rhodium/bisphosphite ligand complex catalyst. Rhodium catalyst precursors are exemplified by rhodium dicarbonyl acetylacetonate, Rh₂O₃, Rh₄(CO)₁₂, Rh₆(CO)₁₆, and Rh(NO₃)₃.

For example, a rhodium precursor, such as rhodium dicarbonyl acetylacetonate, optionally starting material (D), a solvent, and (C1) the bisphosphite ligand may be combined, e.g., by any convenient means such as mixing. The resulting rhodium/bisphosphite ligand complex may be introduced into the reactor, optionally with excess bisphosphite ligand. Alternatively, the rhodium precursor, (D) the solvent, and the bisphosphite ligand may be combined in the reactor with starting material (A) and/or (B), the alkenyl-functional organosilicon compound; and the rhodium/bisphosphite ligand complex may form in situ. The relative amounts of bisphosphite ligand and rhodium precursor are sufficient to provide a molar ratio of bisphosphite ligand/Rh of 10/1 to 1/1, alternatively 5/1 to 1/1, alternatively 3/1 to 1/1, alternatively 2.5/1 to 1.5/1. In addition to the rhodium/bisphosphite ligand complex, excess (e.g., not complexed) bisphosphite ligand may be present in the reaction mixture. The excess bisphosphite ligand may be the same as, or different from, the bisphosphite ligand in the complex.

The amount of (C) the rhodium/bisphosphite ligand complex catalyst (catalyst) is sufficient to catalyze hydroformylation of (B) the alkenyl-functional organosilicon compound. The exact amount of catalyst will depend on various factors including the type of alkenyl-functional organosilicon compound selected for starting material (B), its exact alkenyl content, and the reaction conditions such as temperature and pressure of starting material (A). However, the amount of (C) the catalyst may be sufficient to provide a rhodium metal concentration of at least 0.1 ppm, alternatively 0.15 ppm, alternatively 0.2 ppm, alternatively 0.25 ppm, and alternatively 0.5 ppm, based on the weight of (B) the alkenyl-functional organosilicon compound. At the same time, the amount of (C) the catalyst may be sufficient to provide a rhodium metal concentration of up to 300 ppm, alternatively up to 100 ppm, alternatively up to 20 ppm, and alternatively up to 5 ppm, on the same basis. Alternatively, the amount of (C) the catalyst may be sufficient to provide 0.1 ppm to 300 ppm, alternatively 0.2 ppm to 100 ppm, alternatively, 0.25 ppm to 20 ppm, and alternatively 0.5 ppm to 5 ppm, based on the weight of (B) the alkenyl-functional organosilicon compound.

The hydroformylation process reaction may run without additional solvents. Alternatively, the hydroformylation process reaction may be carried out with a solvent, for example to facilitate mixing and/or delivery of one or more of the starting materials described above, such as the (C) catalyst and/or starting material (B), when a solvent such as an alkenyl-functional polyorganosilicate resin is selected for starting material (B). The solvent is exemplified by aliphatic or aromatic hydrocarbons, which can dissolve the starting materials, e.g., toluene, xylene, benzene, hexane, heptane, decane, cyclohexane, or a combination of two or more thereof. Additional solvents include THF, dibutyl ether, diglyme, and Texanol. Without wishing to be bound by theory, it is thought that solvent may be used to reduce the viscosity of the starting materials. The amount of solvent is not critical, however, when present, the amount of solvent may be 5% to 70% based on weight of starting material (B) the alkenyl-functional organosilicon compound.

In the process described herein, step 1) is performed at relatively low temperature. For example, step 1) may be performed at a temperature of at least 30° C., alternatively at least 50° C., and alternatively at least 70° C. At the same time, the temperature in step 1) may be up to 150° C.; alternatively up to 100° C.; alternatively up to 90° C., and alternatively up to 80° C. Without wishing to be bound by theory, it is thought that lower temperatures, e.g., 30° C. to 90° C., alternatively 40° C. to 90° C., alternatively 50° C. to 90° C., alternatively 60° C. to 90° C., alternatively 70° C. to 90° C., alternatively 80° C. to 90° C., alternatively 30° C. to 60° C., alternatively 50° C. to 60° C. may be desired for achieving high selectivity and ligand stability.

In the process described herein, step 1) may be performed at a pressure of at least 101 kPa (ambient), alternatively at least 206 kPa (30 psi), and alternatively at least 344 kPa (50 psi). At the same time, pressure in step 1) may be up to 6,895 kPa (1,000 psi), alternatively up to 1,379 kPa (200 psi), alternatively up to 1000 kPa (145 psi), and alternatively up to 689 kPa (100 psi). Alternatively, step 1) may be performed at 101 kPa to 6,895 kPa; alternatively 344 kPa to 1,379 kPa; alternatively 101 kPa to 1,000 kPa; and alternatively 344 kPa to 689 kPa. Without wishing to be bound by theory, it is thought that using relatively low pressures, e.g., <6,895 kPa in the process herein may be beneficial; the ligands described herein allow for low pressure hydroformylation processes, which have the benefits of lower cost and better safety than high pressure hydroformylation processes. Furthermore, the hydroformylation process has the benefit of being robust in that a wide variety of alkenyl-functional organosilicon compounds can be converted to aldehyde-functional organosilicon compounds (from a silane to a polyorganosiloxane resin), as shown the examples below.

The hydroformylation process may be carried out in a batch, semi-batch, or continuous mode, using one or more suitable reactors, such as a fixed bed reactor, a fluid bed reactor, a continuous stirred tank reactor (CSTR), or a slurry reactor. The selection of (B) the alkenyl-functional organosilicon compound, and (C) the catalyst, and whether (D) the solvent, is used may impact the size and type of reactor used. One reactor, or two or more different reactors, may be used. The hydroformylation process may be conducted in one or more steps, which may be affected by balancing capital costs and achieving high catalyst selectivity, activity, lifetime, and ease of operability, as well as the reactivity of the particular starting materials and reaction conditions selected, and the desired product.

Alternatively, the hydroformylation process may be performed in a continuous manner. For example, the process used may be as described in U.S. Pat. No. 10,023,516 except that the olefin feed stream and catalyst described therein are replaced with (B) the alkenyl-functional organosilicon compound and (C) the rhodium/bisphosphite ligand complex catalyst, each described herein.

Step 1) of the hydroformylation process forms a reaction fluid comprising the aldehyde-functional organosilicon compound. The reaction fluid may further comprise additional materials, such as those which have either been deliberately employed, or formed in situ, during step 1) of the process. Examples of such materials that can also be present include unreacted (B) alkenyl-functional organosilicon compound, unreacted (A) carbon monoxide and hydrogen gases, and/or in situ formed side products, such as ligand degradation products and adducts thereof, and high boiling liquid aldehyde condensation byproducts, as well as (D) a solvent, if employed. The term “ligand degradation product” includes but is not limited to any and all compounds resulting from one or more chemical transformations of at least one of the ligand molecules used in the process.

The hydroformylation process may further comprise one or more additional steps such as: 2) recovering (C) the rhodium/bisphosphite ligand complex catalyst from the reaction fluid comprising the aldehyde-functional organosilicon compound. Recovering (C) the rhodium/bisphosphite ligand complex catalyst may be performed by methods known in the art, including but not limited to adsorption and/or membrane separation (e.g., nanofiltration). Suitable recovery methods are as described, for example, in U.S. Pat. No. 5,681,473 to Miller, et al.; U.S. Pat. No. 8,748,643 to Priske, et al.; and 10,155,200 to Geilen, et al.

However, one benefit of the process described herein is that (C) the hydroformylation reaction catalyst need not be removed and recycled. Due to the low level of Rh needed, it may be more cost effective not to recover and recycle (C) the catalyst; and the aldehyde-functional organosilicon compound produced by the process may be stable even when the catalyst is not removed. Furthermore, without wishing to be bound by theory, it is thought that (C) the hydroformylation reaction catalyst may also catalyze the oxidation reaction of the aldehyde-functional organosilicon compound, as described herein below. Therefore, alternatively, the hydroformylation process described above may be performed without step 2).

Alternatively, the hydroformylation process may further comprise 3) purification of the reaction product. For example, the aldehyde-functional organosilicon compound may be isolated from the additional materials, described above, by any convenient means such as stripping and/or distillation, optionally with reduced pressure. Alternatively, step 3) may be omitted, for example, to leave (C) the hydroformylation reaction catalyst in the hydroformylation reaction product comprising the aldehyde-functional organosilicon compound.

The aldehyde-functional organosilicon compound is useful as a starting material in the process described above for preparing a carboxy-functional organosilicon compound. Starting material (E) is the aldehyde-functional organosilicon compound, which has, per molecule, at least one aldehyde-functional group covalently bonded to silicon. Alternatively, the aldehyde-functional organosilicon compound may have, per molecule, more than one aldehyde-functional group covalently bonded to silicon. The aldehyde-functional group covalently bonded to silicon may have formula:

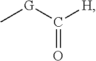

where G is a divalent hydrocarbon group free of aliphatic unsaturation that has 2 to 8 carbon atoms. G may be linear or branched. Examples of divalent hydrocarbyl groups for G include alkane-diyl groups of empirical formula —CᵣH₂ᵣ—, where subscript r is 2 to 8. The alkane-diyl group may be a linear alkane-diyl, e.g., —CH₂—CH₂—, —CH₂—CH₂—CH₂—, —CH₂—CH₂—CH₂—CH₂—, or —CH₂—CH₂—CH₂—CH₂—CH₂—CH₂—, or a branched alkane-diyl, e.g.,

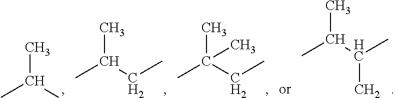

Alternatively, each G may be an alkane-diyl group of 2 to 6 carbon atoms; alternatively of 2, 3, or 6 carbon atoms. The aldehyde-functional organosilicon compound may be one aldehyde-functional organosilicon compound. Alternatively, two or more aldehyde-functional organosilicon compounds that differ from one another may be used in the process described herein. For example, the aldehyde-functional organosilicon compound may comprise one or both of an aldehyde-functional silane and an aldehyde-functional polyorganosiloxane.

The aldehyde-functional organosilicon compound may comprise an aldehyde-functional silane of formula (E1): R^{Ald}ₓSiR⁴₍₄₋ₓ₎, where each R^{Ald} is an independently selected group of the formula

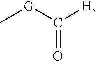

as described above; and R⁴ and subscript x are as described above, e.g., each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

Suitable aldehyde-functional silanes are exemplified by aldehyde-functional trialkylsilanes such as (propyl-aldehyde)-trimethylsilane, (propyl-aldehyde)-triethylsilane, and (butyl-aldehyde)trimethylsilane; aldehyde-functional trialkoxysilanes such as (butyl-aldehyde)trimethoxysilane, (propyl-aldehyde)-trimethoxysilane, (propyl-aldehyde)-triethoxysilane, (propyl-aldehyde)-triisopropoxysilane, and (propyl-aldehyde)-tris(methoxyethoxy)silane; aldehyde-functional dialkoxysilanes such as (propyl-aldehyde)-phenyldiethoxysilane, (propyl-aldehyde)-methyldimethoxysilane, and (propyl-aldehyde)-methyldiethoxysilane; aldehyde-functional monoalkoxysilanes such as tri(propyl-aldehyde)-methoxysilane; aldehyde-functional triacyloxysilanes such as (propyl-aldehyde)-triacetoxysilane, and aldehyde-functional diacyloxysilanes such as (propyl-aldehyde)-methyldiacetoxysilane.

Alternatively, the aldehyde-functional organosilicon compound may comprise (E2) an aldehyde-functional polyorganosiloxane. Said aldehyde-functional polyorganosiloxane may be cyclic, linear, branched, resinous, or a combination of two or more thereof. Said aldehyde-functional polyorganosiloxane may comprise unit formula (E2-1): (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(SiO_{4/2})_{g}(ZO_{1/2})ₕ; where each R^{Ald} is an independently selected aldehyde group of the formula

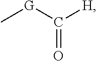

as described above, and R⁴, Z, and subscripts a, b, c, d, e, f, g, and h are as described above. Each R⁴ is independently selected from the group consisting of an alkyl group of 1 to 18 carbon atoms, an aryl group of 6 to 18 carbon atoms, and an hydrocarbonoxy group of 1 to 18 carbon atoms. Each Z is independently selected from the group consisting of a hydrogen atom and R⁵, where each R⁵ is independently selected from the group consisting of alkyl groups of 1 to 18 carbon atoms and aryl groups of 6 to 18 carbon atoms. Subscripts a, b, c, d, e, f, and g represent average numbers, per molecule, of each unit in the unit formula. Subscripts a, b, c, d, e, f, and g and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, 10,000≥(a+b+c+d+e+f+g)≥2, and a quantity (b+d+f)≥1. At the same time, the quantity (a+b+c+d+e+f+g) may be ≤10,000. When e=f=g=0, then h≥0. Alternatively, in the unit formula (E2-1) for the aldehyde-functional polyorganosiloxane, each R⁴ may be independently selected from the group consisting of a hydrogen atom, an alkyl group of 1 to 18 carbon atoms, an aryl group of 6 to 18 carbon atoms, and a hydrocarbonoxy-functional group of 1 to 18 carbon atoms. Alternatively, each R⁴ may be independently selected from the group consisting of an alkyl group of 1 to 18 carbon atoms, an aryl group of 6 to 18 carbon atoms, and an alkoxy-functional group of 1 to 18 carbon atoms. Alternatively, each R⁴ may be independently selected from the group consisting of an alkyl group of 1 to 18 carbon atoms and an aryl group of 6 to 18 carbon atoms. Alternatively, each Z may be hydrogen or an alkyl group of 1 to 6 carbon atoms. Alternatively, each Z may be hydrogen.

Alternatively, (E2) the aldehyde-functional polyorganosiloxane may comprise (E2-2) a linear polydiorganosiloxane having, per molecule, at least one aldehyde-functional group; alternatively at least two aldehyde-functional groups (e.g., when in the formula (E2-1) for the aldehyde-functional polyorganosiloxane above, subscripts e=f=g=0). For example, said polydiorganosiloxane may comprise unit formula (E2-3): (R⁴₃SiO_{1/2})ₐ(R^{Ald}R⁴₂SiO_{1/2})_{b}(R⁴₂SiO_{2/2})_{c}(R^{Ald}R⁴SiO_{2/2})_{d}, where R^{Ald} and R⁴ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2. Alternatively, in the unit formula (E2-3) for the linear aldehyde-functional polyorganosiloxane, above, the quantity (a+b+c+d) may be at least 3, alternatively at least 4, and alternatively≥50. At the same time said formula, the quantity (a+b+c+d) may be less than or equal to 10,000; alternatively less than or equal to 4,000; alternatively less than or equal to 2,000; alternatively less than or equal to 1,000; alternatively less than or equal to 500; alternatively less than or equal to 250. Alternatively, in the unit formula for the linear aldehyde-functional polyorganosiloxane, each R⁴ may be independently selected from the group consisting of alkyl and aryl; alternatively methyl and phenyl. Alternatively, each R⁴ in said formula may be an alkyl group; alternatively each R⁴ may be methyl.

Alternatively, the linear aldehyde-functional polydiorganosiloxane of unit formula (E2-3) may be selected from the group consisting of: unit formula (E2-4): (R⁴₂R^{Ald}SiO_{1/2})₂(R⁴₂SiO_{2/2})ₘ(R⁴R^{Ald}SiO_{2/2})ₙ, unit formula (E2-5): (R⁴₃SiO_{1/2})₂(R⁴₂SiO_{2/2})ₒ(R⁴R^{Ald}SiO_{2/2})ₚ, or a combination of both (E2-4) and (E2-5).

In formulae (E2-4) and (E2-5), each R⁴ and R^{Ald} are as described above. Subscript m may be 0 or a positive number. Alternatively, subscript m may be at least 2. Alternatively subscript m be 2 to 2,000. Subscript n may be 0 or a positive number. Alternatively, subscript n may be 0 to 2000. Subscript o may be 0 or a positive number. Alternatively, subscript o may be 0 to 2000. Subscript p is at least 2. Alternatively subscript p may be 2 to 2000.

Starting material (E2) may comprise an aldehyde-functional polydiorganosiloxane such as i) bis-dimethyl(propyl-aldehyde)siloxy-terminated polydimethylsiloxane, ii) bis-dimethyl(propyl-aldehyde)siloxy-terminated poly(dimethylsiloxane/methyl(propyl-aldehyde)siloxane), iii) bis-dimethyl(propyl-aldehyde)siloxy-terminated polymethyl(propyl-aldehyde)siloxane, iv) bis-trimethylsiloxy-terminated poly(dimethylsiloxane/methyl(propyl-aldehyde)siloxane), v) bis-trimethylsiloxy-terminated polymethyl(propyl-aldehyde)siloxane, vi) bis-dimethyl(propyl-aldehyde)siloxy-terminated poly(dimethylsiloxane/methylphenylsiloxane/methyl(propyl-aldehyde)siloxane), vii) bis-dimethyl(propyl-aldehyde)siloxy-terminated poly(dimethylsiloxane/methylphenylsiloxane), viii) bis-dimethyl(propyl-aldehyde)siloxy-terminated poly(dimethylsiloxane/diphenylsiloxane), ix) bis-phenyl,methyl,(propyl-aldehyde)-siloxy-terminated polydimethylsiloxane, x) bis-dimethyl(heptyl-aldehyde)siloxy-terminated polydimethylsiloxane, xi) bis-dimethyl(heptyl-aldehyde)siloxy-terminated poly(dimethylsiloxane/methyl(heptyl-aldehyde)siloxane), xii) bis-dimethyl(heptyl-aldehyde)siloxy-terminated polymethyl(heptyl-aldehyde)siloxane, xiii) bis-trimethylsiloxy-terminated poly(dimethylsiloxane/methyl(heptyl-aldehyde)siloxane), xiv) bis-trimethylsiloxy-terminated polymethyl(heptyl-aldehyde)siloxane, xv) bis-dimethyl(heptyl-aldehyde)-siloxy terminated poly(dimethylsiloxane/methylphenylsiloxane/methyl(heptyl-aldehyde)siloxane), xvi) bis-dimethyl(propyl-aldehyde)siloxy-terminated poly(dimethylsiloxane/methyl(heptyl-aldehyde)siloxane), xvii) bis-dimethyl(heptyl-aldehyde)-siloxy-terminated poly(dimethylsiloxane/methylphenylsiloxane), xviii) dimethyl(heptyl-aldehyde)-siloxy-terminated poly(dimethylsiloxane/diphenylsiloxane), and xix) a combination of two or more of i) to xviii).

Alternatively, (E2) the aldehyde-functional polyorganosiloxane may be cyclic, e.g., when in unit formula (E2-1), subscripts a=b=c=e=f=g=h=0. The (E2-6) cyclic aldehyde-functional polydiorganosiloxane may have unit formula (E2-7): (R⁴R^{Ald}SiO_{2/2})_{d}, where R^{Ald} and R⁴ are as described above, and subscript d may be 3 to 12, alternatively 3 to 6, and alternatively 4 to 5. Examples of cyclic aldehyde-functional polydiorganosiloxanes include 2,4,6-trimethyl-2,4,6-tri(propyl-aldehyde)-cyclotrisiloxane, 2,4,6,8-tetramethyl-2,4,6,8-tetra(propyl-aldehyde)-cyclotetrasiloxane, 2,4,6,8,10-pentamethyl-2,4,6,8,10-penta(propyl-aldehyde)-cyclopentasiloxane, and 2,4,6,8,10,12-hexamethyl-2,4,6,8,10,12-hexa(propyl-aldehyde)-cyclohexasiloxane.

Alternatively, (E2-6) the cyclic aldehyde-functional polydiorganosiloxane may have unit formula (E2-8): (R⁴₂SiO_{2/2})_{c}(R⁴R^{Ald}SiO_{2/2})_{d}, where R⁴ and R^{Ald} are as described above, subscript c is >0 to 6 and subscript d is 3 to 12. Alternatively, in formula (E2-8), a quantity (c+d) may be 3 to 12. Alternatively, in formula (E2-8), c may be 3 to 6, and d may be 3 to 6.

Alternatively, (E2) the aldehyde-functional polyorganosiloxane may be (E2-9) oligomeric, e.g., when in unit formula (E2-1) above the quantity (a+b+c+d+e+f+g)≤50, alternatively≤40, alternatively≤30, alternatively≤25, alternatively≤20, alternatively≤10, alternatively≤5, alternatively≤4, alternatively≤3. The oligomer may be cyclic, linear, branched, or a combination thereof. The cyclic oligomers are as described above as starting material (E2-6).

Examples of linear aldehyde-functional polyorganosiloxane oligomers may have formula (E2-10):

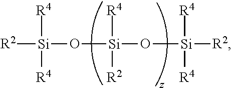

where R⁴ is as described above, each R² is independently selected from the group consisting of R⁴ and R^{Ald}, with the proviso that at least one R², per molecule, is R^{Ald}, and subscript z is 0 to 48. Examples of linear aldehyde-functional polyorganosiloxane oligomers include 1,3-di(propyl-aldehyde)-1,1,3,3-tetramethyldisiloxane; 1,1,1,3,3-pentamethyl-3-(propyl-aldehyde)-disiloxane; and 1,1,1,3,5,5,5-heptamethyl-3-(propyl-aldehyde)-trisiloxane.

Alternatively, the aldehyde-functional polyorganosiloxane oligomer may be branched. The branched oligomer may have general formula (E2-11): R^{Ald}SiR¹²₃, where R^{Ald} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100. At least two of R¹² may be —OSi(R¹⁴)₃. Alternatively, all three of R¹² may be —OSi(R¹⁴)₃.

Alternatively, in formula (E2-11) when each R¹² is —OSi(R¹⁴)₃, each R¹⁴ may be —OSi(R¹⁵)₃ moieties such that the branched polyorganosiloxane oligomer has the following structure:

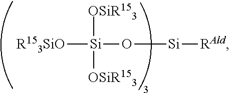

where R^{Ald} and R¹⁵ are as described above. Alternatively, each R¹⁵ may be an R¹³, as described above, and each R¹³ may be methyl.

Alternatively, in formula (E2-11), when each R¹² is —OSi(R¹⁴)₃, one R¹⁴ may be R¹³ in each —OSi(R¹⁴)₃ such that each R¹² is —OSiR¹³(R¹⁴)₂. Alternatively, two R¹⁴ in —OSiR¹³(R¹⁴)₂ may each be —OSi(R¹⁵)₃ moieties such that the branched aldehyde-functional polyorganosiloxane oligomer has the following structure:

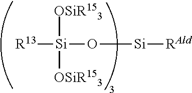

where R^{Ald}, R¹³, and R¹⁵ are as described above. Alternatively, each R¹⁵ may be an R¹³, and each R¹³ may be methyl.

Alternatively, in formula (B2-11), one R¹² may be R¹³, and two of R¹² may be —OSi(R¹⁴)₃. When two of R¹² are —OSi(R¹⁴)₃, and one R¹⁴ is R¹³ in each —OSi(R¹⁴)₃ then two of are —OSiR¹³(R¹⁴)₂. Alternatively, each R¹⁴ in —OSiR¹³(R¹⁴)₂ may be —OSi(R⁵)₃ such that the branched polyorganosiloxane oligomer has the following structure:

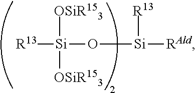

where R^{Ald}, R¹³, and R¹⁵ are as described above. Alternatively, each R¹⁵ may be an R¹³, and each R¹³ may be methyl. Alternatively, the aldehyde-functional branched polyorganosiloxane may have 3 to 16 silicon atoms per molecule, alternatively 4 to 16 silicon atoms per molecule, and alternatively 4 to 10 silicon atoms per molecule. Examples of aldehyde-functional branched polyorganosiloxane oligomers include 3-(1,1,1,5,5,5-hexamethyl-3-((trimethylsilyl)oxy)trisiloxan-3-yl)propanal (which can also be named propyl-aldehyde-tris(trimethyl)siloxy)silane), which has formula:

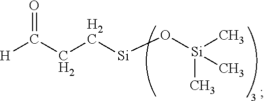

(propyl-aldehyde)-di((1,1,1,3,5,5,5-heptamethyltrisiloxan-3-yl)oxy)-silane, which has formula

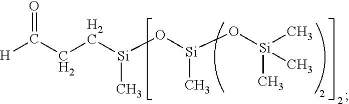

(propyl-aldehyde)-tris((1,1,1,3,5,5,5-heptamethyltrisiloxan-3-yl)oxy)-silane, which has formula

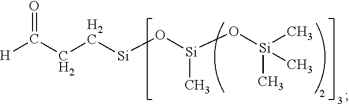

and (heptyl-aldehyde)-tris((1,1,1,3,5,5,5-heptamethyltrisiloxan-3-yl)oxy)-silane, which has formula

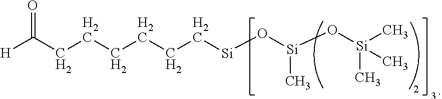

Alternatively, (E2) the aldehyde-functional polyorganosiloxane may be branched, such as the branched oligomer described above and/or a branched aldehyde-functional polyorganosiloxane that may have, e.g., more aldehyde groups per molecule and/or more polymer units than the branched oligomer described above (e.g., in formula (E2-1) when the quantity (a+b+c+d+e+f+g)>50). The branched aldehyde-functional polyorganosiloxane may have (in formula (E2-1)) a quantity (e+f+g) sufficient to provide>0 to 5 mol % of trifunctional and/or quadrifunctional units to the branched aldehyde-functional polyorganosiloxane.

For example, the branched aldehyde-functional polyorganosiloxane may comprise a Q branched polyorganosiloxane of unit formula (E2-13): (R⁴₃SiO_{1/2})_{q}(R⁴₂R^{Ald}SiO_{1/2})ᵣ(R⁴₂SiO_{2/2})ₛ(SiO_{4/2})ₜ, where R⁴ and R^{Ald} are as described above, and subscripts q, r, s, and t have average values such that 2≥q≥0, 4≥r≥0, 995≥s≥4, t=1, (q+r)=4, and (q+r+s+t) has a value sufficient to impart a viscosity>170 mPa·s measured by rotational viscometry (as described below with the test methods) to the branched polyorganosiloxane. Alternatively, viscosity may be >170 mPa·s to 1000 mPa·s, alternatively>170 to 500 mPa·s, alternatively 180 mPa·s to 450 mPa·s, and alternatively 190 mPa·s to 420 mPa·s.

Alternatively, the branched aldehyde-functional polyorganosiloxane may comprise formula (E2-14): [R^{Ald}R⁴₂Si—(O—SiR⁴₂)ₓ—O]_{(4-W)}—Si—[O—(R⁴₂SiO)ᵥSiR⁴₃]_{w}, where R^{Ald} and R⁴ are as described above; and subscripts v, w, and x have values such that 200≥v≥1, 2≥w≥0, and 200≥x≥1. Alternatively, in this formula (E2-14), each R⁴ is independently selected from the group consisting of methyl and phenyl, and each R^{Ald} has the formula above, wherein G has 2, 3, or 6 carbon atoms.

Alternatively, the branched aldehyde-functional polyorganosiloxane for starting material (E2-11) may comprise a T branched polyorganosiloxane (silsesquioxane) of unit formula (E2-15): (R⁴₃SiO_{1/2})ₐₐ(R^{Ald}R⁴₂SiO_{1/2})_{bb}(R⁴₂SiO_{2/2})_{cc}(R^{Ald}R⁴SiO_{2/2})ₑₑ(R⁴SiO_{3/2})_{dd}, where R⁴ and R^{Ald} are as described above, subscript aa≥0, subscript bb>0, subscript cc is 15 to 995, subscript dd>0, and subscript ee≥0. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb>0; alternatively 12≥bb≥3; alternatively 10≥bb>0; alternatively 7≥bb>1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may be 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd>0; alternatively 5≥dd>0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (E2-15) with an aldehyde content of 0.1% to 1%, alternatively 0.2% to 0.6%, based on the weight of the silsesquioxane.

Alternatively, (E2) the aldehyde-functional polyorganosiloxane may comprise an aldehyde-functional polyorganosiloxane resin, such as an aldehyde-functional polyorganosilicate resin and/or an aldehyde-functional silsesquioxane resin. Such resins may be prepared, for example, by hydroformylating an alkenyl-functional polyorganosiloxane resin, as described above. The aldehyde-functional polyorganosilicate resin comprises monofunctional units (“M′” units) of formula R^{M′}₃SiO_{1/2} and tetrafunctional silicate units (“Q” units) of formula SiO_{4/2}, where each R^{M′} may be independently selected from the group consisting of R⁴ and R^{Ald} as described above. Alternatively, each R^{M′} may be selected from the group consisting of an alkyl group, an aldehyde-functional group of the formula shown above, and an aryl group. Alternatively, each R^{M′} may be selected from methyl, (propyl-aldehyde) and phenyl. Alternatively, at least one-third, alternatively at least two thirds of the R^{M′} groups are methyl groups. Alternatively, the M′ units may be exemplified by (Me₃SiO_{1/2}), (Me₂PhSiO_{1/2}), and (Me₂R^{Ald}SiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M′ and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M′}₃)₄, where R^{M′} is as described above, e.g., the neopentamer may be tetrakis(trimethylsiloxy)silane. ²⁹Si NMR and ¹³C NMR spectroscopies may be used to measure hydroxyl and alkoxy content and molar ratio of M′ and Q units, where said ratio is expressed as {M′(resin)}/{Q(resin)}, excluding M′ and Q units from the neopentamer. M′/Q ratio represents the molar ratio of the total number of triorganosiloxy groups (M′ units) of the resinous portion of the polyorganosilicate resin to the total number of silicate groups (Q units) in the resinous portion. M′/Q ratio may be 0.5/1 to 1.5/1, alternatively 0.6/1 to 0.9/1.

The Mn of the polyorganosilicate resin depends on various factors including the types of hydrocarbon groups represented by R^{M′} that are present. The Mn of the polyorganosilicate resin refers to the number average molecular weight measured using GPC, when the peak representing the neopentamer is excluded from the measurement. The Mn of the polyorganosilicate resin may be 1,500 Da to 30,000 Da, alternatively 1,500 Da to 15,000 Da; alternatively>3,000 Da to 8,000 Da. Alternatively, Mn of the polyorganosilicate resin may be 3,500 Da to 8,000 Da.

Alternatively, the polyorganosilicate resin may comprise unit formula (E2-17): (R⁴₃SiO_{1/2})ₘₘ(R⁴₂R^{Ald}SiO_{1/2})ₙₙ(SiO_{4/2})ₒₒ(ZO_{1/2})ₕ, where Z, R⁴, and R^{Ald}, and subscript h are as described above and subscripts mm, nn and oo have average values such that mm≥0, nn>0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/oo≤4.

Alternatively, (E2) the aldehyde-functional polyorganosiloxane may comprise (E2-18) an aldehyde-functional silsesquioxane resin, i.e., a resin containing trifunctional (T′) units of unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(ZO_{1/2})ₕ; where R⁴ and R^{Ald} are as described above, subscript f>1, 2<(e+f)<10,000; 0<(a+b)/(e+f)<3; 0<(c+d)/(e+f)<3; and 0<h/(e+f)<1.5. Alternatively, the aldehyde-functional silsesquioxane resin may comprise unit formula (E2-19): (R⁴SiO_{3/2})ₑ(R^{Ald}SiO_{3/2})_{f}(ZO_{1/2})ₕ, where R⁴, R^{Ald}, Z, and subscripts h, e and f are as described above. Alternatively, the alkenyl-functional silsesquioxane resin may further comprise difunctional (D′) units of formulae (R⁴₂SiO_{2/2})_{c}(R⁴R^{Ald}SiO_{2/2})_{d} in addition to the T units described above, i.e., a D′T′ resin, where subscripts c and d are as described above. Alternatively, the alkenyl-functional silsesquioxane resin may further comprise monofunctional (M′) units of formulae (R⁴₃SiO_{1/2})ₐ(R⁴₂R^{Ald}SiO_{1/2})_{b}, i.e., an M′D′T′ resin, where subscripts a and b are as described above for unit formula (E2-1).

Starting material (E) may be any one of the aldehyde-functional organosilicon compounds described above. Alternatively, starting material (E) may comprise a mixture of two or more of the aldehyde-functional organosilicon compounds.

The process for preparing the carboxy-functional organosilicon compound may comprise:
I) combining, under conditions to conduct oxidation reaction, starting materials comprising
   (E) the aldehyde-functional organosilicon compound described above,
   (F) an oxygen source,
   optionally (G) an oxidation reaction catalyst, and
   optionally (H) a solvent; thereby forming an oxidation reaction product comprising the carboxy-functional organosilicon compound.

The process may optionally comprise one or more additional steps. For example, the process may further comprise, before step I), 1) combining, under conditions to catalyze hydroformylation reaction, starting materials comprising (A) the gas comprising hydrogen and carbon monoxide, (B) the alkenyl-functional organosilicon compound, and (C) the rhodium/bisphosphite ligand complex catalyst, thereby forming a hydroformylation reaction product comprising the aldehyde-functional organosilicon compound as described above. The process may optionally further comprise, before step I) and after step 1), step 2) recovering (C) the rhodium/bisphosphite ligand complex catalyst from the reaction product comprising the aldehyde-functional organosilicon compound. The process may optionally further comprise, before step I) and after step 1), 3) purifying the reaction product; thereby isolating the aldehyde-functional organosilicon compound from the additional materials, as described above. Alternatively, step 2) and/or step 3) may be omitted for the reasons discussed above. Alternatively, in addition to, or instead of, the steps recited above, the process may optionally further comprise: drying one or more of the starting materials before step I).

The process may optionally further comprise: II) equilibrating the carboxy-functional organosilicon compound with a cyclic polydiorganosiloxane in the presence of an equilibration catalyst. Alternatively, in addition to, or instead of step II), the process may optionally further comprise: III) recovering the carboxy-functional organosilicon compound from the oxidation reaction product. Step III) may be performed during and/or after step I), and/or when step II) is present, during and/or after step III).

### (F) Oxygen Source

Oxygen sources are known in the art and readily available. For example, the oxygen source may be ambient air, which comprises 21% oxygen. Alternatively, the oxygen source may be concentrated or purified oxygen, e.g., any gas stream with 21% to 100% oxygen. Pure or nearly pure (>99% pure) oxygen is known in the art and commercially available from various sources, e.g., Air Products of Allentown, Pennsylvania, USA. Alternatively, the oxygen source may comprise a peroxide compound (i.e., a compound having at least one —O—O— group per molecule). Suitable peroxide compounds include an organic hydroperoxide such as an alkyl hydroperoxide (e.g., tert-butyl hydroperoxide), a dialkyl peroxide (e.g., di-tert-butyl peroxide), a peroxyacid (such as 3-chloroperbenzoic acid), or a combination thereof. The oxygen source may be used in an amount sufficient to provide a superstoichiometric amount of oxygen with respect to the aldehyde-functionality of starting material (E), the aldehyde-functional organosilicon compound described above. The amount of oxygen source (and reaction conditions) is sufficient to permit oxidation of at least one of the aldehyde-functional groups, per molecule, of the aldehyde-functional organosilicon compound. Alternatively, some of the aldehyde-functional groups may be converted to carboxylic acid groups. Alternatively, complete conversion of aldehyde-functional groups to carboxylic acid functional groups may be performed.

### (G) Oxidation Reaction Catalyst

The oxidation reaction catalyst used in the process for preparing the carboxy-functional organosilicon compound may be a heterogeneous oxidation reaction catalyst, a homogenous oxidation reaction catalyst, or a combination thereof.

An exemplary oxidation reaction catalyst may comprise a metal complex or compound. The metal complex or compound may comprise a metal selected from the group consisting of cobalt (Co), copper (Cu), iron (Fe), Manganese (Mn), Nickel (Ni), Rhodium (Rh), Selenium (Se), and Tungsten (W), and combinations of two or more thereof. For example, manganese acetate (Mn(OAc)₂) may be used. Non-metal based catalysts may also be suitable, such as those described in RSCAdv., 2013, 3, 18931-18937. The metal complex may further comprise a ligand, such as acetate. Alternatively, the oxidation reaction catalyst may comprise Rh. Without wishing to be bound by theory, it is thought that when the hydroformylation process described above is used to make the aldehyde-functional organosilicon compound, and the Rh complex used as (C) the hydroformylation reaction catalyst is present, this Rh complex may serve as oxidation reaction catalyst. Alternatively, (G) the oxidation reaction catalyst may comprise an organocatalyst containing N-hydroxy functionality. Exemplary organocatalysts include N-hydroxyphthalimide or 2,2,6,6-tetramethylpiperidin-1-yl)oxyl (TEMPO). Suitable oxidation reaction catalysts are known in the art and are commercially available. For example, N-hydroxyphthalimide and TEMPO are commercially available from various sources including Sigma-Aldrich, Inc. of St. Louis, Missouri, USA.

The amount of (G) the oxidation reaction catalyst used in the process depends on various factors including whether the process will be run in a batch or continuous mode, the selection of aldehyde-functional organosilicon compound, whether a heterogeneous or homogeneous oxidation reaction catalyst is selected, and reaction conditions such as temperature and pressure. However, the amount of catalyst (for the batch process or a continuous process using a homogeneous oxidation catalyst) may be 0.001 mole % to 1 mole %, alternatively 0.005 mole % to 0.5 mole %, based on moles of the aldehyde-functional group in starting material (E) the aldehyde-functional organosilicon compound. Alternatively, the amount of catalyst may be at least 0.001, alternatively at least 0.005, alternatively at least 0.01, and alternatively at least 0.1, mole %; while at the same time the amount of catalyst may be up to 1, alternatively up to 0.75, alternatively up to 0.5, alternatively up to 0.25, and alternatively up to 0.1, mole %, on the same basis. Alternatively, when the process will be run in a continuous mode, e.g., by packing a reactor with a heterogeneous oxidation reaction catalyst, the amount of the oxidation reaction catalyst may be sufficient to provide a reactor volume (filled with oxidation reaction catalyst) to achieve a space time of 10 hr⁻¹, or catalyst surface area sufficient to achieve 8 to 10 kg/hr substrate per m² of catalyst.

### (H) Solvent

A solvent that may optionally be used in the process for oxidation reaction may be selected from those solvents that are neutral to the oxidation reaction. The following are specific examples of such solvents: ketones such as acetone and 3-pentanone; esters; carboxylic acids; aliphatic hydrocarbons, such as hexane, heptane, and paraffinic solvents; and aromatic hydrocarbons such as benzene, toluene, ethylbenzene, and xylene. These solvents can be used individually or in combinations of two or more.

The oxidation reaction in step I) can be performed using a pressurized oxygen source. Partial pressure of the oxygen may be 3 psia (20 kPa) to 100 psia (690 kPa), alternatively 3 psia (20 kPa) to 15 psia (104 kPa). The reaction may be carried out at a temperature of 0 to 200° C. The temperature in step I) may depend on various factors such as the pressure selected, the aldehyde-functional organosilicon compound selected, and the reactor configuration. Without wishing to be bound by theory, it is thought that oxidation reaction rate may increase as temperature increases, but oxygen solubility in the aldehyde-functional organosilicon compound may decreases as temperature increase, therefore, temperature may be selected so as to have sufficient oxygen solubility to allow the oxidation reaction to proceed while maximizing reaction rate. The temperature may be, for example, 0° C. to 100° C. Alternatively, a temperature of 23° C. to 100° C., and alternatively 20° C. to 50° C., may be suitable. Alternatively, the oxygen source partial pressure used may be at least 3, alternatively at least 4, alternatively at least 6, alternatively at least 8, and alternatively at least 10, psia; while at the same time the pressure may be up to 100, alternatively up to 75, alternatively up to 50, alternatively up to 25, and alternatively up to 15, psia. The temperature for oxidation reaction may be at least 20, alternatively at least 25, alternatively at least 30, ° C., while at the same time the temperature may be up to 100, alternatively up to 95, and alternatively up to 90, ° C.

The oxidation reaction can be carried out as a batch process or as a continuous process. In a batch process, the reaction time depends on various factors including the amount of the catalyst and reaction temperatures, however, step I) of the process described herein may be performed for 1 minute to 250 hours. Alternatively, the oxidation reaction may be performed for at least 1 minute, alternatively at least 2 minutes, alternatively at least 1 hour, alternatively at least 2.5 hours, alternatively at least 3 hours, alternatively at least 3.3 hours, alternatively at least 3.7 hours, alternatively at least 4 hours, alternatively at least 4.4 hours, and alternatively at least 5.5 hours; while at the same time, the oxidation reaction may be performed for up to 250 hours, alternatively 200 hours, alternatively up to 175 hours, alternatively up to 150 hours, alternatively up to 125 hours, alternatively up to 100 hours, and alternatively up to 75 hours.

Alternatively, in a batch process, the terminal point of an oxidation reaction can be considered to be the time during which the decrease in pressure of the oxygen source is no longer observed after the reaction is continued for an additional 1 to 2 hours. If oxygen source pressure decreases in the course of the reaction, it may be desirable to repeat the introduction of the oxygen source and to maintain it under increased pressure to shorten the reaction time. Alternatively, the reactor can be re-pressurized with the oxygen source 1 or more times to achieve sufficient supply of oxygen for reaction of the aldehyde while maintaining reasonable reactor pressures. The same oxygen source, or a different oxygen source (e.g., more concentrated in 02) may be used when re-pressurizing the reactor to finish oxidation of the aldehyde.

The oxidation reaction in step I) may optionally further comprise irradiating the reaction mixture with ultra-violet (UV) radiation. UV radiation may have a peak wavelength of 285 nm and may be provided by any convenient means such as an LED or other lamp. Alternatively, UV radiation with a wavelength of 200 nm to 460 nm; alternatively 250 nm to 350 nm, and alternatively 265 nm to 315 nm may be used. The exposure dose depends on various factors including the wavelength selected and other reaction conditions. For example, a UV dosage of 9 μW/cm² may be used. Without wishing to be bound by theory, it is thought that UV irradiation may increase rate of the oxidation reaction in step I).

After the oxidation reaction, the oxidation reaction catalyst may be separated in a pressurized atmosphere by any convenient means, such as filtration or adsorption, e.g., with diatomaceous earth or activated carbon, settling, centrifugation, by maintaining the catalyst in a structured packing or other fixed structure, or a combination thereof.

The carboxy-functional organosilicon compound prepared as described above has, per molecule, at least one carboxy-functional group covalently bonded to silicon. Alternatively, the carboxy-functional organosilicon compound may have, per molecule, more than one carboxy-functional group covalently bonded to silicon. The carboxy-functional group covalently bonded to silicon, R^{Car}, may have formula:

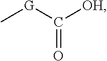

where G is a divalent hydrocarbon group free of aliphatic unsaturation that has 2 to 8 carbon atoms, as described and exemplified above. The carboxy-functional organosilicon compound may have any one of the formulas shown above for the aldehyde-functional organosilicon compound, with the proviso that one or more instances of R^{Ald} is replaced with R^{Car}. The carboxy-functional organosilicon compound may have a formula as shown below in the embodiments.

### EXAMPLES

These examples are provided to illustrate the invention to one of ordinary skill in the art and should not be construed to limit the scope of the invention set forth in the claims. Starting Materials used in the examples are described below in Table 1.

TABLE 1
Starting Materials

| Type | Name | Chemical Description | Source |
|---|---|---|---|
| Solvent | Toluene | C₇H₈ | Fisher |
| | | | Chemical |
| Solvent | Heptane | C₇H₁₆ | Fisher |
| | | | Chemical |
| Solvent | 3-pentanone | CH₃CH₂COCH₂CH₃ | Sigma- |
| | | | Aldrich |
| Catalyst | N-hydroxyphthalimide | C₈H₅NO₃ | Sigma- |
| | | | Aldrich |
| Cyclosiloxane | D4 | | DSC |
| Hydroformylation | (Acetylacetonato) | Rh(acac)(CO)2 | Unknown |
| Catalyst | dicarbonylrhodium(I) | | |
| Precursor | | | |
| Ligand 1 | 6,6′-[[3,3′,5,5′-tetrakis(1,1- | | TDCC |
| | dimethylethyl)-1,1′-biphenyl]-2,2′- | | |
| | diyl]bis(oxy)]bis-dibenzo[d,f] | | |
| | [1,3,2]dioxaphosphepin | | |
| Vinylsiloxane | vinylmethylbis(trimethylsiloxy)silane | MD^{Vi}M | DSC |
| 1 | | | |
| Vinylsiloxane | 1,3-divinyltetramethyldisiloxane | M^{Vi}M^{Vi} | DSC |
| 2 | | | |
| Vinylsiloxane | 2,4,6,8-Tetramethyl-2,4,6,8- | D^{Vi}₄ | DSC |
| 3 | tetravinylcyclotetrasiloxane | | |
| Vinylsiloxane | 3,3′- | M^{Vi}D₇M^{Vi} | DSC |
| 4 | (1,1,3,3,5,5,7,7,9,9,11,11,13,13,15,15, | | |
| | 17,17-octadecamethylnonasiloxane- | | |
| | 1,17-diyl)divinyl | | |
| Vinylsiloxane | Bis-trimethylsioxy-terminated | MD_{8.2} D^{vi}_{3.7}M | DSC |
| 5 | poly(dimethyl/methylvinyl)siloxane | | |
| | with an average, per molecule, of 8.2 | | |
| | dimethyl siloxy units and an average | | |
| | of 3.7 methylvinylsiloxy units | | |
| Vinylsiloxane | Bis-dimethylvinylsiloxy-terminated | M^{Vi}₂D₁₈₀ | DSC |
| 6 | polydimethylsiloxane with average | | |
| | DP = 180 | | |
| | 5-((1,1,1,3,5,5,5- | Si10 Vi | Synthesized |
| | heptamethyltrisiloxan-3-yl)oxy)- | | internally |
| | 1,1,1,3,7,9,9,9-octamethyl-3,7- | | at DSC, |
| | bis((trimethylsilyl)oxy)-5- | | using the |
| | vinylpentasiloxane | | synthesis |
| | | | described |
| | | | above |
| | 5-((1,1,1,3,5,5,5- | Si10 Hex | Synthesized |
| | heptamethyltrisiloxan-3-yl)oxy)-5- | | internally |
| | (hex-5-en-1-yl)-1,1,1,3,7,9,9,9- | | at DSC, |
| | octamethyl-3,7- | | using the |
| | bis((trimethylsilyl)oxy)pentasiloxane | | synthesis |
| | | | described |
| | | | above |
| Vinylsiloxane | Bis-dimethylvinylsiloxy-terminated | M^{Vi}₂D₃₂₉ | DSC |
| 7 | polydimethylsiloxane with an average | | |
| | of 329 dimethylsiloxy (D) units per | | |
| | molecule | | |
| Vinylsiloxane | Bis-dimethylvinylsiloxy-terminated | M^{Vi}₂D₂₅ | DSC |
| 8 | polydimethylsiloxane with an average | | |
| | of 25 dimethylsiloxy (D) units per | | |
| | molecule | | |
| Vinylsiloxane | Bis-dimethylvinylsiloxy-terminated | M^{Vi}₂D₇₇ | DSC |
| 16 | polydimethylsiloxane with an average | | |
| | of 77 dimethylsiloxy (D) units per | | |
| | molecule | | |
| Vinyl Silane 1 | Vinyltrimethylsilane | Me₃SiCH═CH₂ | Gelest |
| Vinyl | Ethoxydimethyl(vinyl)silane | Me₂Si(OEt)Vi | Gelest |
| Alkoxysilane 1 | | | |
| Aldehyde- | 3-(1,1,1,3,5,5,5- | MD^{Pr-Ald}M, | Synthesis |
| siloxane 1 | heptamethyltrisiloxan-3-yl)propanal | C10H26O3Si3 | Example |
| | | | 1, below. |
| Aldehyde- | 3,3′-(1,1,3,3-tetramethyldisiloxane- | M^{Pr-Ald}M^{Pr-Ald}, | Synthesis |
| siloxane 2 | 1,3-diyl)dipropanal | C10H22O3Si2 | Example |
| | | | 2, below. |
| Aldehyde- | Tetrapropanal- | D^{Pr-Ald}₄, | Synthesis |
| siloxane 3 | tetramethylcyclotetrasiloxane | C16H32O8Si4 | Example |
| | | | 3, below. |
| Aldehyde- | Propylaldehyde terminated PDMS | M^{Pr-ald}D₇M^{Pr-ald} | Synthesis |
| siloxane 4 | (DP = 7) | | Example |
| | | | 7 |
| Aldehyde- | Hydroformylation products of | MD_{8.2}D^{Pr-ald}_{3.7}M | Synthesis |
| siloxane 5 | MD_{8.2}D^{vi}_{3.7}M | | Example |
| | | | 9 |
| Aldehyde- | Propyl-aldehyde terminated PDMS | M^{Pr-ald}₂D₁₈₀ | Synthesis |
| siloxane 6 | (DP = 180) | | Example |
| | | | 8 |
| Aldehyde- | Propyl-aldehyde terminated PDMS | M^{Pr-ald}₂D₃₂₉ | Synthesis |
| siloxane 7 | (DP = 329) | | Example |
| | | | 10 |
| Aldehyde- | Propyl-aldehyde terminated PDMS | M^{Pr-ald}₂D₂₅ | Synthesis |
| siloxane 8 | (DP = 25) | | Example |
| | | | 11 |
| Aldehyde- | Propyl-aldehyde terminated PDMS | M^{Pr-ald}₂D₇₇ | Synthesis |
| siloxane 9 | (DP = 77) | | Example |
| | | | 12 |
| Aldehyde- | (M₂T)₃T Propionaldehyde | See Synthesis | |
| siloxane | | Example 13 | |
| Aldehyde- | (M₂T)₃T heptanealdehyde | See Synthesis | |
| siloxane | | Example 14 | |
| Hexenyl- | Q branched-hexenyl-siloxane | Q-(D₃₆M^{hex})4 | Synthesis |
| siloxane | | | Example |
| | | | 4, below. |
| Allyl-Siloxane | Allyl terminated PDMS (DP = 102) | | Synthesis |
| | | | Example |
| | | | 5, below. |
| Vi-MQ resin | DOWSIL ™ 6-3444, Resin of unit | Methyl- and vinyl- | DSC |
| | formula | functional | |
| | (Me₃SiO_{1/2})₄₀(Me₂ViSiO_{1/2})₄(SiO_{4/2})₅₆ | polyorganosilicate | |
| | | resin with an average | |
| | | of 40 trimethylsiloxy | |
| | | (M) units, 4 | |
| | | dimethylvinylsiloxy | |
| | | (MVi) units and 56 | |
| | | tetrasiloxy units per | |
| | | molecule | |
| Aldehyde-MQ | Hydroformylation products of MQ | | Synthesis |
| resin | resin (DOWSIL ™ 6-3444 Int) | | Example |
| | | | 6. |
| D4 | Octamethylcyclotetrasiloxane | (Me₂SiO_{2/2})₄ | DSC |
| Acid | DOWEX ™ DR-2030 | Acid ion exchange | TDCC |
| Equilibration | | resin | |
| Catalyst 1 | | | |
| Acid | Triflic Acid | CF₃SO₃H | Sigma- |
| Equilibration | | | Aldrich |
| Catalyst 2 | | | |
| Aldehyde | 3-(ethoxydimethylsilyl)propanal | Me₂Si(OEt)CH₂CH₂CHO, | Synthesis |
| Alkoxysilane 1 | | C7H16O2Si | Example |
| | | | 15 |
| Aldehyde | 3-(trimethylsilyl)propanal | Me₃SiCH₂CH₂CHO | Synthesis |
| Silane 1 | | | Example |
| | | | 16. |
| Oxidant 1 | 3-chloroperbenzoic acid | C₇H5ClO₃ | Sigma- |
| | | | Aldrich |
| Oxidant 2 | Tert-butyl peroxide | C₈H₁₈O₂ | Sigma- |
| | | | Aldrich |
| Oxidant 3 | Tert-butyl hydroperoxide (5-6M in | Hydroperoxide | Sigma- |
| | decane) | formula: C₄H₁₀O₂ | Aldrich |

In this Synthesis Example 1, the procedure for making 3-(1,1,1,3,5,5,5-heptamethyltrisiloxan-3-yl)propanal (Aldehyde siloxane 1) was performed as follows: In a nitrogen filled glovebox, Rh(acac)(CO)₂ (6.7 mg, 0.026 mmol), Ligand 1 (30.2 mg, 0.0360 mmol) and toluene (5.0 g, 0.054 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, vinylmethylbis(trimethylsiloxy)silane (20.2 g, 81.2 mmol) and the toluene (57.7 g, 627 mmol) were loaded to a 300-mL Parr-reactor. The reactor was sealed and loaded into the holder. The reactor was pressurized with nitrogen up to 100 psi via the dip-tube and was carefully relieved through a valve connected to the headspace for three times. The reactor was then pressure tested by pressurizing to 300 psi with nitrogen. After the pressure was released, the catalyst solution was added to the reactor via the sample loading port. The reactor was pressurized with syngas to 100 psi and then released for three times prior to being pressurized 80 psi via the dip-tube. Reaction temperature was set to 90° C. Agitation rate was set to 500 RPM. The intermediate cylinder containing syngas and the reactor were connected when the desired temperature was reached. The pressure was set to 100 psi. The reaction progress was monitored by a data logger which measured the pressure in the 300 ml intermediate cylinder as it supplied syngas to the reactor via a pressure reducing regulator. N/I ratio was determined by ¹H NMR analysis of the final product.

In this Synthesis Example 2, the procedure for making 3,3′-(1,1,3,3-tetramethyldisiloxane-1,3-diyl)dipropanal (Aldehyde siloxane 2) was performed as follows: In a nitrogen filled glovebox, Rh(acac)(CO)₂ (18.1 mg, 0.0699 mmol), Ligand 1_(88.0 mg, 0.105 mmol) and toluene (5.0 g, 0.054 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, 1,3-divinyltetramethyldisiloxane (44.8 g, 240 mmol) and the toluene (40.0 g, 488 mmol) were loaded to a 300-mL Parr-reactor. The reactor was sealed and loaded into the holder. The reactor was pressurized with nitrogen up to 100 psi via the dip-tube and was carefully relieved through a valve connected to the headspace for three times. The reactor was then pressure tested by pressurizing to 300 psi with nitrogen. After the pressure was released, the catalyst solution was added to the reactor via the sample loading port. The reactor was pressurized with syngas to 100 psi and then released for three times prior to being pressurized 80 psi via the dip-tube. Reaction temperature was set to 90° C. Agitation rate was set to 500 RPM. The intermediate cylinder containing syngas and the reactor were connected when the desired temperature was reached. The pressure was set to 100 psi. The reaction progress was monitored by a data logger which measured the pressure in the 300 ml intermediate cylinder as it supplied syngas to the reactor via a pressure reducing regulator. N/I ratio was determined by ¹H NMR analysis of the final product.

In this Synthesis Example 3, the procedure for making Tetrapropanal-tetramethylcyclotetrasiloxane (Aldehyde siloxane 3) was performed as follows: In a nitrogen filled glovebox, Rh(acac)(CO)₂ (5.9 mg, 0.019 mmol), Ligand 1 (28.6 mg, 0.0341 mmol) and toluene (5.0 g, 0.054 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, 2,4,6,8-Tetramethyl-2,4,6,8-tetravinylcyclotetrasiloxane (45.0 g, 130 mmol) and the toluene (40.0 g, 488 mmol) were loaded to a 300-mL Parr-reactor. The reactor was sealed and loaded into the holder. The reactor was pressurized with nitrogen up to 100 psi via the dip-tube and was carefully relieved through a valve connected to the headspace for three times. The reactor was then pressure tested by pressurizing to 300 psi with nitrogen. After the pressure was released, the catalyst solution was added to the reactor via the sample loading port. The reactor was pressurized with syngas to 100 psi and then released for three times prior to being pressurized 80 psi via the dip-tube. Reaction temperature was set to 90° C. Agitation rate was set to 500 RPM. The intermediate cylinder containing syngas and the reactor were connected when the desired temperature was reached. The pressure was set to 100 psi. The reaction progress was monitored by a data logger which measured the pressure in the 300 ml intermediate cylinder as it supplied syngas to the reactor via a pressure reducing regulator. N/I ratio was determined by ¹H NMR analysis of the final product.

In this Synthesis Example 4, the syntheses of Q branched hexenyl polyorganosiloxane polymers were performed as follows:

### A. Synthesis of Hexenyl Neopentamer

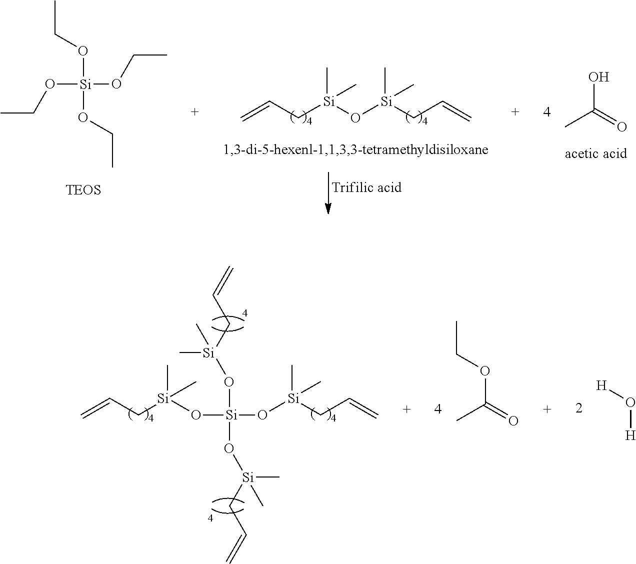

In a typical procedure, a 500 ml multi-neck reactor was equipped with a thermocouple, overhead stirrer, nitrogen-sweep and a dean-stark trap with condenser. The reactor was charged with 1,3-di-5-hexenyl-1,1,3,3-tetramethyldisiloxane (78.84 g, 0.26 mol, 0.55 equivalent) and acetic acid (129.7 g, 2.16 mol, 4.5 equivalent) were charged into and purged with overhead nitrogen. Triflic acid (0.3089 g, 2.1 mmol, 0.1 wt %) was added dropwise into the reactor using a syringe. Then the mixture in the reactor was stirred and heated to 45° C. under N₂. Tetraethoxysilane (TEOS, 100 g, 0.48 mol, 1 equivalent) was added dropwise into the reaction mixture via an addition funnel and the reaction mixture temperature maintained at 45-50° C. during TEOS addition. After TEOS addition was done, the reaction proceeded at 80° C. until the reaction was complete. The reaction was monitored by GC-MS. The reaction mixture was cooled down to room temperature after reaction was complete, followed by washing with DI water twice, saturated NaHCO₃ solution three times and DI water twice again. The raw product was dried over anhydrous Na₂SO₄ and then stripped at 180° C. to remove the residual volatiles. A pale yellow oil was obtained (yield=88%).

B. Synthesis of Q-branched Hexenyl Polyorganosiloxane Q-(D₃₆M^{hex})4

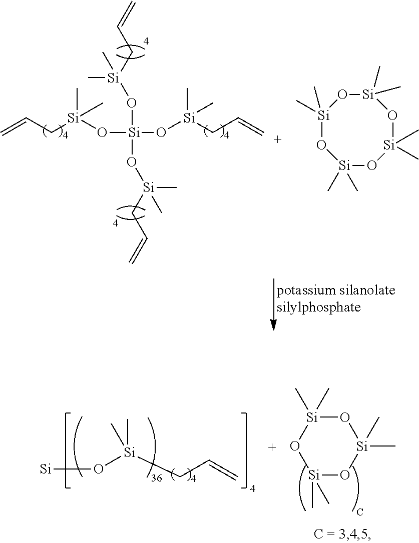

or more

In a nitrogen filled glovebox, Rh(acac)(CO)₂ (75.5 mg, 0.292 mmol), Ligand 1(489.1 mg, 0.58 mmol) and toluene (10.0 g, 0.108 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, Q-branched hexenyl siloxane (150 g, 13.59 mmol) was loaded to a 300-mL Parr-reactor. The reactor was sealed and loaded into the holder. The reactor was pressurized with nitrogen up to 100 psi via the dip-tube and was carefully relieved through a valve connected to the headspace for three times. The reactor was then pressure tested by pressurizing to 300 psi with nitrogen. After the pressure was released, the catalyst solution was added to the reactor via the sample loading port. The reactor was pressurized with syngas to 100 psi and then released for three times prior to being pressurized 80 psi via the dip-tube. Reaction temperature was set to 70° C. Agitation rate was set to 600 RPM. The intermediate cylinder containing syngas and the reactor were connected when the desired temperature was reached. The pressure was set to 100 psi. The reaction progress was monitored by a data logger which measured the pressure in the 300 ml intermediate cylinder as it supplied syngas to the reactor via a pressure reducing regulator. N/I ratio was determined by ¹H NMR analysis of the final product.

In this Synthesis Example 5, Allyl-Siloxane described in Table 1 was prepared as follows: In a typical procedure, a 500 ml multi-neck reactor was equipped with a thermocouple, overhead stirrer, nitrogen-sweep and a dean-stark trap with condenser. The reactor was charged with 1,3-diallyltetramethyldisiloxane(13.81 g, 64.38 mmol, 1 equivalent) and octamethylcyclotetrasiloxane (D4, 487 g, 1.64 mol, 25.5 equivalent) and purged with overhead nitrogen. The mixture in the reactor was stirred and heated to 140° C. under nitrogen atmosphere and dilute potassium silanolate (10 wt % in D4, 1.2809 g) was then added into the reactor. The reaction proceeded at 140° C. for 4 hours and was monitored by offline NMR. When the reaction was complete, octylsilyl phosphonate (2.5 wt % in D4, 2.967 g) was added into the reactor to neutralize the reaction. Then the heat was turned off to allow the reactor to cool to ambient temperature. The final Allyl-Siloxane was obtained by stripping off the volatile cyclics under vacuum.

In this Synthesis Example 6, Aldehyde-MQ resin described in Table 1 was prepared as follows: In a nitrogen filled glovebox, Rh(acac)(CO)2 (3.8 mg, 0.0147 mmol), Ligand 1 (27.28 mg, 0.0325 mmol) and toluene (5.0 g, 57.9 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, vinyl-MQ resin (DOWSIL™ 6-3444 Int) (37.5 g) and the toluene (112.5 g, 1.22 mol) were loaded to a 300-mL Parr-reactor. The reactor was sealed and loaded into the holder. The reactor was pressurized with nitrogen up to 100 psi via the dip-tube and was carefully relieved through a valve connected to the headspace for three times. The reactor was then pressure tested by pressurizing to 300 psi with nitrogen. After the pressure was released, the catalyst solution was added to the reactor via the sample loading port. The reactor was pressurized with syngas to 100 psi and then released for three times prior to being pressurized 80 psi via the dip-tube. Reaction temperature was set to 70° C. Agitation rate was set to 500 RPM. The intermediate cylinder containing syngas and the reactor were connected when the desired temperature was reached. The pressure was set to 100 psi. The reaction progress was monitored by a data logger which measured the pressure in the 300 ml intermediate cylinder as it supplied syngas to the reactor via a pressure reducing regulator. N/I ratio was determined by ¹H NMR analysis of the final product.

In this Synthesis Example 7, 3,3′-(1,1,3,3,5,5,7,7,9,9,11,11,13,13,15,15,17,17-octadecamethylnonasiloxane-1,17-diyl)dipropanal (M^{Pr-ald}D₇M^{Pr-ald}) was prepared as follows. In a nitrogen filled glovebox, Rh(acac)(CO)₂ (9.3 mg, 0.0359 mmol), Ligand 1 (58.1 mg, 0.069 mmol) and heptane (10.0 g, 99.8 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, 3,3′-(1,1,3,3,5,5,7,7,9,9,11,11,13,13,15,15,17,17-octadecamethylnonasiloxane-1,17-diyl)divinyl (M^{Vi}D₇M^{Vi}) from DSC (700 g, 1.027 mol) was loaded to a 2-L Autoclave-reactor. The reactor was sealed and loaded into the holder. The reactor was pressurized with nitrogen up to 100 psi via the dip-tube and was carefully relieved through a valve connected to the headspace for three times. The reactor was then pressure tested by pressurizing to 300 psi with nitrogen. After the pressure was released, the catalyst solution was added to the reactor via the sample loading port. The reactor was pressurized with syngas to 100 psi and then released for three times prior to being pressurized 80 psi via the dip-tube. Reaction temperature was set to 70° C. Agitation rate was set to 800 RPM The intermediate cylinder containing syngas and the reactor were connected when the desired temperature was reached. The pressure was set to 100 psi. The reaction progress was monitored by a data logger which measured the pressure in the intermediate cylinder as it supplied syngas to the reactor via a pressure reducing regulator. The resulting product contained 3,3′-(1,1,3,3,5,5,7,7,9,9,11,11,13,13,15,15,17,17-octadecamethylnonasiloxane-1,17-diyl)dipropanal (M^{Pr-ald}D₇M^{Pr-ald}), Aldehyde-siloxane 4 in Table 1.

In this Synthesis Example 8, M^{Vi}₂D₁₈₀, was hydroformylated to form M^{Pr-ald}D₁₈₀M^{Pr-ald}, as follows. In a nitrogen filled glovebox, Rh(acac)(CO)₂ (0.0050 g), Ligand 1 (0.0326 g) and toluene (5.0 g) were added into a 60 mL vial with a magnetic stir bar. The mixture was stirred at RT on a stir plate until a homogeneous solution was formed. The solution was transferred to an air-tight syringe with a metal valve and subsequently removed from the glove box. In a ventilated fume hood, M^{Vi}₂D₁₈₀ (200 g) from DSC was loaded to the Parr-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (689 kPa) and then vented for three times prior to being pressurized to 20 psig (138 kPa) below the desired pressure via the dip-tube. Reaction temperature was set to 70° C. Heater and agitation were turned on. The 300 mL intermediate cylinder containing the syngas for the reaction and the reactor were connected when the desired temperature was reached. Pressure drop from a 300 mL intermediate cylinder was used to monitor the reaction progress and was recorded by a data logger. Full conversion of vinyl groups was observed after 3.5 hours reaction time as monitored by ¹H NMR.

In this Synthesis Example 9, MD_{8.2} D^{Pr-Ald}_{3.7}M was synthesized as follows: In a nitrogen filled glovebox, Rh(acac)(CO)₂ (0.0191 g), Ligand 1 (0.1324 g) and toluene (76.74 g) were added into a 125 mL bottle with a magnetic stir bar. The mixture was stirred at room temperature on a stir plate until a homogeneous solution was formed. 3.65 g of the solution was transferred to an air-tight syringe with a metal valve and subsequently removed from the glove box. In a ventilated fume hood, MD_{8.2}D^{vi}_{3.7}M (180 g) from DSC was loaded to the Parr-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (689 kPa) and then vented for three times prior to being pressurized to 20 psig (138 kPa) below the desired pressure via the dip-tube. Reaction temperature was set to 70° C. Heater and agitation were turned on. The 300 mL intermediate cylinder containing the syngas for the reaction and the reactor were connected when the desired temperature was reached. Pressure drop from a 300 mL intermediate cylinder was used to monitor the reaction progress and was recorded by a data logger. Full conversion of vinyl groups was observed after 24 hours reaction time as monitored by ¹H NMR.

In this Synthesis Example 10, hydroformylation of Vinylsiloxane 7, M^{vi}₂D₃₂₉, was performed, as follows: In a nitrogen filled glovebox, Rh(acac)(CO)₂ (0.380 g), Ligand 1 (2.45 g) and toluene (90 g) were added into a 125 mL vial with a magnetic stir bar. The mixture was stirred at RT on a stir plate until a homogeneous solution was formed. Then 8.6 g of the solution was transferred to an air-tight syringe with a metal valve and subsequently removed from the glove box. In a ventilated fume hood, M^{vi}₂D₃₂₉ (1394 g) was loaded to a 2 liter Autoclave-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (689 kPa) and then vented for three times prior to being pressurized to 20 psig (138 kPa) below the desired pressure via the dip-tube. Reaction temperature was set to 90° C. Heater and agitation were turned on. The cylinder containing the syngas for the reaction and the reactor were connected when the desired temperature was reached. A mass flow totalizer was used to monitor the reaction progress. Full conversion of vinyl groups was observed after stirring overnight as determined by ¹H NMR; M^{Pr-Ald}₂D₃₂₉ formed.

In this Example 11, hydroformylation of Vinylsiloxane 8, M^{Vi}₂D₂₅, was performed, as follows: In a nitrogen filled glovebox, Rh(acac)(CO)₂ (0.0252 g), Ligand 1 (1.63 g) and toluene (50 g) were added into a 125 mL vial with a magnetic stir bar. The mixture was stirred at RT on a stir plate until a homogeneous solution was formed. The solution was transferred to an air-tight syringe with a metal valve and subsequently removed from the glove box. In a ventilated fume hood, M^{Vi}₂D₂₅ (1000 g) was loaded to a 2 liter Autoclave-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (689 kPa) and then vented for three times prior to being pressurized to 20 psig (138 kPa) below the desired pressure via the dip-tube. Reaction temperature was set to 80° C. Heater and agitation were turned on. The cylinder containing the syngas for the reaction and the reactor were connected when the desired temperature was reached. A mass flow totalizer was used to monitor the reaction progress. Full conversion of vinyl groups was observed after 2 hours reaction time as monitored by ¹H NMR; M^{Pr-Ald}₂D₂₅ formed.

In this Synthesis Example 12, hydroformylation of Vinylsiloxane 16, M^{Vi}₂D₇₇, was performed, as follows: In a nitrogen filled glovebox, Rh(acac)(CO)₂ (0.0050 g), Ligand 1 (0.0227 g) and toluene (30.09 g) were added into a 60 mL vial with a magnetic stir bar. The mixture was stirred at RT on a stir plate until a homogeneous solution was formed. The solution was transferred to an air-tight syringe with a metal valve and subsequently removed from the glove box. In a ventilated fume hood, M^{Vi}₂D₇₇ (140.12 g) and toluene (46.92 g) were loaded to the Parr-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (689 kPa) and then vented for three times prior to being pressurized to 20 psig (138 kPa) below the desired pressure via the dip-tube. Reaction temperature was set to 90° C. Heater and agitation were turned on. The 300 mL intermediate cylinder containing the syngas for the reaction and the reactor were connected when the desired temperature was reached. Pressure drop from a 300 mL intermediate cylinder was used to monitor the reaction progress and was recorded by a data logger. Full conversion of vinyl groups was observed after 10 hours reaction time as monitored by ¹H NMR; M^{Pr-Ald}₂D₇₇ formed.

In this Synthesis Example 13, hydroformylation of a branched oligomer was performed as follows:

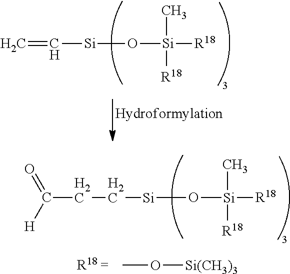

In a nitrogen filled glovebox, Rh(acac)(CO)₂ (15.1 mg, 0.0583 mmol), Ligand 1 (76.4 mg, 0.0911 mmol) and toluene (7.49 g, 0.0814 mmol) were added into a 30 mL glass vial with a magnetic stir bar. The mixture was stirred on a stir plate until a homogeneous solution formed. This solution was transferred to an air-tight syringe with a metal valve and subsequently removed from the glove box. In a ventilated fume hood, 5-((1,1,1,3,5,5,5-heptamethyltrisiloxan-3-yl)oxy)-1,1,1,3,7,9,9,9-octamethyl-3,7-bis((trimethylsilyl)oxy)-5-vinylpentasiloxane (145.0 g, 189.2 mmol) was loaded to a 300-mL Parr-reactor. The reactor was sealed and loaded into the holder. The reactor was pressurized with nitrogen up to 100 psi (689 kPa) via the dip-tube and was carefully relieved through a valve connected to the headspace for three times. The reactor was then pressure tested by pressurizing to 300 psi (2068 kPa) with nitrogen. After the pressure was released, the catalyst solution was added to the reactor via the sample loading port. The reactor was pressurized with syngas to 100 psi (689 kPa) and then released for three times prior to being pressurized to 80 psi (552 kPa) via the dip-tube. Reaction temperature was set to 100° C. Agitation rate was set to 500 RPM. The intermediate cylinder containing syngas and the reactor were connected when the desired temperature was reached. The pressure was set to 100 psi (689 kPa). The reaction progress was monitored by a data logger which measured the pressure in the 300 mL intermediate cylinder as it supplied syngas to the reactor via a pressure reducing regulator. >98% conversion was observed after 200 minutes. N/I ratio was determined by ¹H NMR analysis of the final product.

In this Synthesis Example 14, hydroformylation of a branched oligomer was performed as follows:

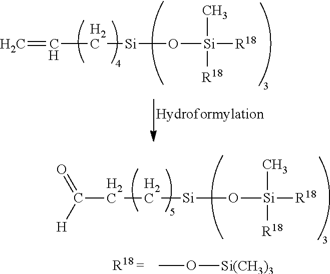

In a nitrogen filled glovebox, Rh(acac)(CO)₂ (25.5 mg, 0.0984 mmol), Ligand 1 (122.3 mg, 0.1457 mmol) and toluene (5.0 g) were added into a 30 mL vial with a magnetic stir bar. The mixture was mixed on a magnetic stir plate until a homogeneous solution formed. The solution was transferred to an air-tight syringe with a metal valve and removed from the glove box. In a fume hood, Si10 Hex (100.0 g, 121.6 mmol) was added to the Parr reactor. The reactor was sealed and loaded into the holder. The reactor was pressurized with nitrogen up to 100 psi (690 kPa) via the dip-tube and was carefully released through headspace for three times. After pressure testing, the catalyst solution was added to the reactor. The reactor was pressurized with syngas to 100 psi and then released for three times prior to being pressurized to 80 psi via the dip-tube. Agitation and heating were initiated. The intermediate cylinder containing syngas and the reactor were connected when the reaction reached 110° C. The pressure of the intermediate cylinder was monitored by a data logger. After the reaction was done, the reactor was purged with nitrogen for three times and the material was transferred to a glass container as a colorless liquid, which turned light yellow over time.

In this Synthesis Example 15, the procedure to make 3-(ethoxydimethylsilyl)propanal (Aldehyde Alkoxysilane 1) was performed, as follows: In a nitrogen filled glovebox, Rh(acac)(CO)₂ (14.3 mg, 0.055 mmol), Ligand 1 (100.9 mg, 0.12 mmol) and toluene (70 g) were added into a 60 mL vial with a magnetic stir bar. The mixture was stirred at RT on a stir plate until a homogeneous solution was formed. The 3.5 g of the solution was transferred to an air-tight syringe with a metal valve and subsequently removed from the glove box. In a ventilated fume hood, Vinyl Alkoxysilane 1, Me₂Si(OEt)Vi, (40 g, 307 mmol) was loaded to the Parr-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (690 kPa) and then vented for three times prior to being pressurized to 109 psig (752 kPa) via the dip-tube. Reaction temperature was set to 70° C. Heater and agitation were turned on. The 300 mL intermediate cylinder containing the syngas for the reaction and the reactor were connected when the desired temperature was reached. Pressure drop from a 300 mL intermediate cylinder was used to monitor the reaction progress and was recorded by a data logger. Full conversion of vinyl groups was observed after 23 hours reaction time as monitored by ¹H NMR; 3-(ethoxydimethylsilyl)propanal formed.

In this Synthesis Example 16, hydroformylation of Vinyltrimethylsilane, was performed, as follows: In a nitrogen filled glovebox, Rh(acac)(CO)₂ (0.0007 g), Ligand 1 (0.0043 g) and toluene (0.90 g) were added into a vial with a magnetic stir bar. The mixture was stirred at RT on a stir plate until a homogeneous solution was formed. The solution was transferred to an air-tight syringe with a metal valve and subsequently removed from the glove box. In a ventilated fume hood, Vinyltrimethylsilane (53.0 g) was loaded to a 300 mL Parr-reactor. The reactor was sealed and pressurized with nitrogen up to 100 psig (689 kPa) via the dip-tube and was carefully relieved through a valve connected to the headspace. The pressure/vent cycle with nitrogen was repeated three times. Pressure testing was subsequently performed by pressurizing the reactor with nitrogen to up to 300 psig (2086 kPa). After the pressure was released, the catalyst solution was added to the reactor via the sample loading port. The reactor was pressurized with syngas to 100 psig (689 kPa) and then vented for three times prior to being pressurized to 20 psig (138 kPa) below the desired pressure via the dip-tube. The reaction temperature was set to 70° C. The heater and agitation were turned on. The reaction was run at 100 psig (689 kPa) syngas pressure. 99.5% conversion of vinyl groups was observed after 20 hours reaction time as monitored by ¹H NMR; propyl-aldehyde functional trimethylsilane was formed.

In this Reference Example A, oxidation of aldehyde-functional organosilicon compounds was performed as follows. In a typical procedure, a 250 ml glass reactor was charged with 150 g of an Aldehyde-siloxane. The aldehyde-siloxane was stirred with a mechanical stirrer or magnetic stirrer and air is continuously injected below the liquid surface with a stainless-steel needle at a rate of 50-200 cc/min. Reaction progress was determined using ¹H NMR analysis and the reactions were continued until high conversion was attained. The aldehyde starting materials and the reaction products mixtures were analyzed by ¹H, ¹³C NMR and ²⁹Si NMR, GC/MS and GPC. The conversion and yield were mainly based on ¹H NMR data.

In this Working Example 1, oxidation of MD^{Pr-Ald}M (the hydroformylation product of MD^{vi}M prepared as described in Synthesis Example 1) was performed according to the procedure in Reference Example A, with the following results.

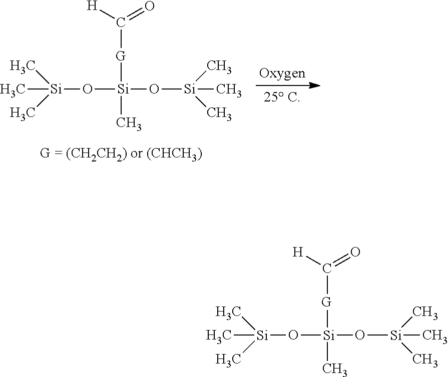

TABLE 3
The results of oxidation batches of MD^{Pr-Ald}M with crude and distilled aldehyde.

| | Mass | | | | Rxn | Conversion of | Linear Acid/ |
|---|---|---|---|---|---|---|---|
| | Aldehyde | | Air rate | Tem. | Time | Aldehyde | branched acid/ |
| Expt. No. | (g) | | (cc/min) | (° C.) | (hr) | (%) | total acid |
| 20CF2124 | 118 | (crude) | 50 | 25 | 118 | 99.7 | 82.3/8.2/90.5 |
| 20CF2130 | 94 | (distilled) | 50 | 25 | 68 | 98.4 | 83.0/7.3/90.4 |

In this Working Example 2, oxidation of MD_{8.2} D^{Pr-Ald}_{3.7}M (the hydroformylation products of Vinylsiloxane 5, MD_{8.2}D^{vi}_{3.7}M, prepared according to Synthesis Example 9) was performed as follows.

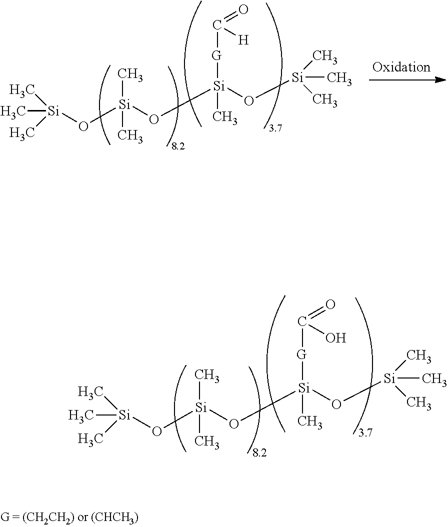

Aldehyde-siloxane 5 (100.4 g) was loaded to a 250 mL reaction flask equipped with a PTFE coated stir bar. Air was bubbled into the liquid subsurface using a needle at 50 cc/min at ambient temperature 20-25° C. The reaction was run for 244 hours to produce 101 g of clear slightly yellow colored product. Product analysis by NMR was conducted using CDCl₃ solvent. 96.8% aldehyde conversion was attained. The product contained 83 mole % linear carboxy-propyl groups and 6.8 mole % branched carboxy-propyl groups (89.8% total acid).

In this Working Example 3, oxidation of Aldehyde-siloxane 2, M^{Pr-Ald}M^{Pr-Ald} (the hydroformylation product of Vinylsiloxane 2, M^{vi}M^{vi} prepared as described in Synthesis Example 2), was performed as follows.

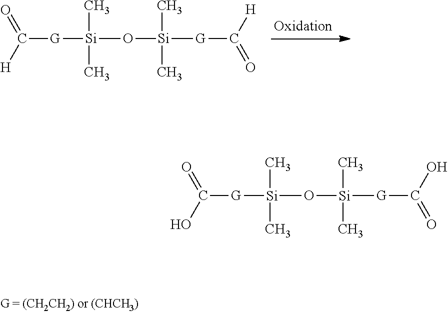

Crude Aldehyde-siloxane 2 (309 g) and 3-pentanone solvent (76 g) were added to a 500 mL reaction flask equipped with an overhead paddle stirrer and a needle for subsurface addition of air. The oxidation reaction was run with an air addition rate of 100 cc/min with 400 rpm agitation. The reaction was continued for 187 hr. 340.9 g of clear, slightly yellow product solution was collected. ¹H NMR analysis showed 96% aldehyde conversion, 91.3 mole % carboxylic acid and 5 mole % formyl ester.

In this Working Example 4, oxidation of Aldehyde-siloxane 4, M^{Pr-Ald}D₇M^{Pr-Ald} a (the hydroformylation product of Vinylsiloxane 4 M^{vi}D₇M^{vi}) prepared according to Synthesis Example 7 was performed as follows.

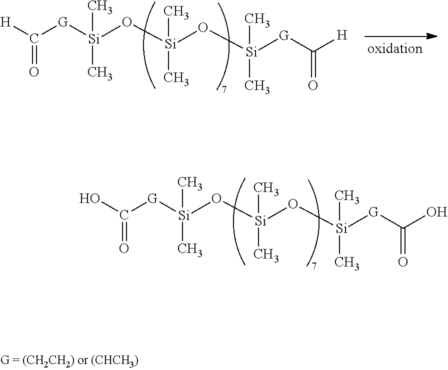

Crude Aldehyde-siloxane 4 (195.3 g) was loaded to a 250 mL European style flask equipped with a PTFE coated magnetic stir bar. Air was sparged subsurface with a needle at 100 cc/min and the mixture was stirred with the magnetic stirrer at maximum speed. The reaction was analyzed by ¹H NMR at 16, 40, and 64 hr. The reaction was stopped after 64 hours. The clear slightly yellow product liquid (194.6 g) was collected. The reaction reached 96.6% aldehyde conversion with 89.7% acid, and 4.0% formyl ester.

In this Working Example 5, oxidation of Aldehyde-siloxane 3, D^{Pr-Ald}₄ (the hydroformylation product of Vinylsiloxane 3, D^{vi}₄) prepared according to Synthesis Example 3, was performed as follows.

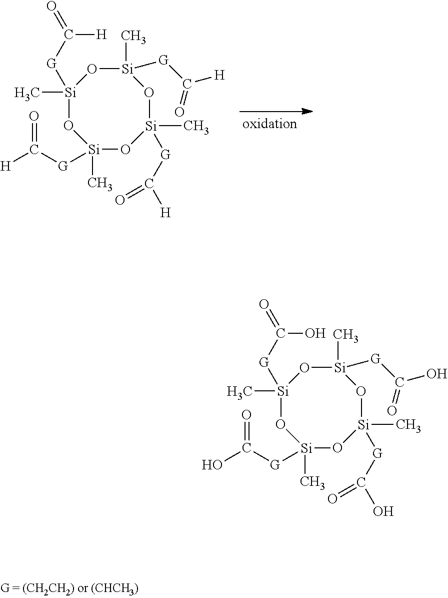

The oxidation reaction was run in 250 mL European style flask with magnetic stirring. 50.25 g of Aldehyde-siloxane 3 was loaded. The reaction was run starting with 80 cc/min air bubbled in sub-surface through a needle at ambient temperature 20-25° C. After 2 hours, 3-pentanone solvent (50 mL) was added and the air rate was increased to 100 cc/min. After 46 hours, additional 3-pentanone (50 mL) was added. After 69 hours, additional 3-pentanone (25 mL) was added. After 77 hours, additional 3-pentanone (50 mL) was added, and the air rate was decreased to 10 cc/min due to sample viscosity. After 165 hours, the reaction was stopped. The reaction was sparged with nitrogen overnight to remove 2.74 g of solvent and 52.17 g of slightly yellow viscous oil was collected.

In this Working Example 6, oxidation of Aldehyde-siloxane 6, M^{Pr-Ald}D₁₈₀M^{Pr-Ald} (the hydroformylation product of Vinylsiloxane 6, M^{Vi}₂D¹⁸⁰) prepared according to Synthesis Example 8 was performed as follows.

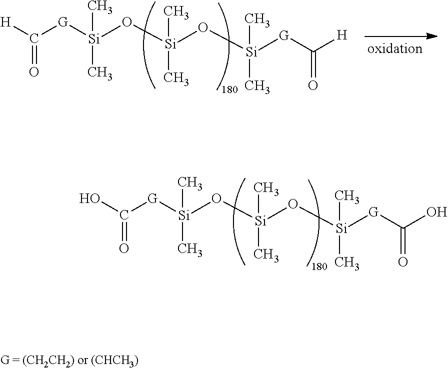

Crude M^{Pr-Ald}D₁₈₀M^{Pr-Ald} solution (189.27 g) was loaded to a 250 mL tapered side glass flask with mechanical overhead stirring. The reaction was run with ˜100 cc/min air starting at ambient temperature of 21.9° C. The reaction was stopped after 67 hours and 98.6% aldehyde conversion. The oxidation reaction product contained 91.8% acid, 2% formyl ester, and 1.4% unreacted aldehyde.

In this Working Example 7, the M^{acid}-D₇-M^{acid} prepared according to Working Example 4 was equilibrated with D4 in the presence of DOWEX™ DR-2030 as follows. The D4 was dried over molecular sieves. M^{acid}-D₇-M^{acid} was dried over molecular sieves and filtered through a 0.45 μm PTFE syringe filter. To a 250 mL reaction flask equipped with an overhead stirrer, thermoprobe, water cooled condenser, nitrogen headspace purge, and heating mantle was added DOWEX™ DR-2030 (0.40 g) and D4 (65.2 g) and heated to 60° C. The M^{acid}-D₇-M^{acid} (13.37 g) was added via syringe. The resulting clear mixture was then stirred at 60° C. overnight for 21 hr to give a clear flowable fluid which was analyzed by Si NMR to show a DP of 74.7. The reaction was continued an additional 3 hours, and while warm, the reaction mixture was filtered through a medium disposable filter funnel to remove catalyst, which gave 75.32 g of clear, slightly viscous liquid. The fluid was stripped on a rotary evaporator at 16 torr and 95° C. for 30 minutes to yield 70.51 g of product fluid. Si NMR analysis of the product fluid showed a DP of 76 and 16% D4.

In this Working Example 8, D4 was dried over molecular sieves. To a 250 mL reaction flask equipped with an overhead stirrer, thermoprobe, heating mantle bar was added DOWEX™ DR-2030 (0.5 g) and D4 (108 g) and heated to 80° C. Using a syringe pump the bis-trimethylsiloxy-terminated poly(dimethyl/methyl, carboxypropyl)siloxane copolymer prepared in Working Example 2 (MD_{8.2}D^{acid}_{3.7}M, 9 g) was added in dropwise over 3 hours. The mixture was then stirred at 80° C. overnight for 14 hrs to give a thick liquid. The reaction mixture contained some gelled material. While warm, the reaction mixture was filtered through a coarse sintered glass funnel to remove gelled material and catalyst and gave 101 g of clear thick liquid. Si NMR indicated a DP of 259.

In this Working Example 9, oxidation of (M2T)3T Propionaldehyde (prepared as described in Synthesis Example 13 was performed as follows.

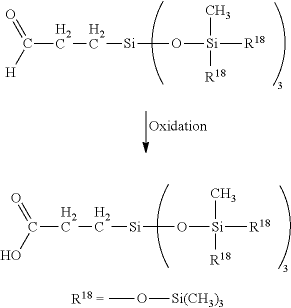

Crude (M2T)3T Propionaldehyde (90 g, 77:1 n:i ratio) was loaded to a 240 mL septa cap bottle equipped with a PTFE coated stir bar. Air was sparged subsurface with a needle at 50 cc/min and the mixture was stirred for 64 hr. The clear slightly yellow liquid (90.0 g) was collected. ¹H NMR analysis of this liquid showed acid, formyl ester, and unreacted aldehyde in a 97.8, 1.82, and 0.39 mole % ratio, respectively.

In this Working Example 10, oxidation of MD^{Pr-Ald}M (prepared as shown in Synthesis Example 1) with 3-pentanone and/or N-hydroxyphthalimide was studied as follows. Four oxidation experiments were set up for oxidation MD^{Pr-Ald}M under different conditions. Experiment A used 3.0 g of neat MD^{Pr-Ald}M. Experiment B used 4.5 g of neat MD^{Pr-Ald}M with 0.04 g (˜1 wt %) N-hydroxyphthalimide. Experiment C used 3.0 g MD^{Pr-Ald}M and 3.0 g 3-pentanone. Experiment D used 2.8 g MD^{Pr-Ald}M, 2.8 g 3-pentanone, and 0.015 g N-hydroxyphthalimide (0.5 wt % relative to MD^{Pr-Ald}M). Each oxidation was run with 10 cc/min air and 500 rpm agitation for 24 hours. The results are shown below in Table 3.

TABLE 3
Starting Materials and Results of Working Example 10

| | | With N- | | With N-hydroxy- |
|---|---|---|---|---|
| | Neat | hydroxy- | With 3- | phthalimide |
| | MD^{Pr-Ald}M | phthalimide | Pentanone | and 3-Pentanone |
| | A | B | C | D |
| linear Ald | 1.9% | 3.6% | 8.0% | 0.6% |
| branched ald | 0.2% | 0.3% | 0.7% | 0.0% |
| Formyl Ester | 3.4% | 2.9% | 2.3% | 2.3% |
| Ester dimer | 0.5% | 0.5% | 0.1% | 0.6% |
| B-silanol | 0.1% | 0.4% | 0.3% | 1.1% |
| Acid n | 88.1% | 86.7% | 83.3% | 89.2% |
| Acid i | 5.8% | 5.7% | 5.4% | 6.2% |
| Total Acid | 93.9% | 92.4% | 88.7% | 95.3% |
| Acid/ | 23.91 | 24.71 | 33.45 | 23.70 |
| impurity | | | | |
| selectivity | | | | |
| Conversion | 97.8% | 96.1% | 91.3% | 99.4% |

In this Working Example 11, oxidation of aldehyde-functional MQ Resin (hydroformylation product prepared according to Synthesis Example 6) was performed as follows. To a 40 mL septa cap vial equipped with a PTFE coated magnetic stir bar was loaded with 25 g of aldehyde-MQ resin from synthesis example 6. Air was bubbled into the solution subsurface at a rate of 20 cc/min at a temperature of 22° C. while stirred with a magnetic stir plate at 1000 RPM. The reaction was continued for 184 hours and the liquid product was collected. Quantitative ¹³C NMR analysis of the product revealed 95% conversion with 83% acid and 12% formyl ester.

In this Working Example 12, oxidation of 3-(ethoxydimethylsilyl)propanal (hydroformylation product prepared according Synthesis Example 15) was performed as follows. A 40 mL vial was charged with a magnetic stirrer and 3-(ethoxydimethylsilyl)propanal [Me₂Si(OEt)CH₂CH₂CHO] (7.16 g, 44.7 mmol). Air was bubbled, subsurface at 40 cc/min. A stir plate was used and set at 1000 RPM. The reaction was monitored by ¹H NMR spectroscopy at 2 h, 21 h, 42 h, and 116 h. The reaction was stopped after 116 h. 4.31 g of pale yellow liquid was collected. Analysis by ¹H NMR spectroscopy revealed 96.2% aldehyde conversion with 95.2% acid and 1.0% formyl ester. The result was further supported by ¹³C NMR spectroscopy data.

In this Working Example 13, oxidation of 3-(ethoxydimethylsilyl)propanal (hydroformylation product prepared according Synthesis Example 15) was performed as follows. A 40 mL vial was charged with a magnetic stirrer and 3-(ethoxydimethylsilyl)propanal [Me₂Si(OEt)CH₂CH₂CHO] (6.96 g, 43.4 mmol). Air was bubbled, subsurface at 5 cc/min. A stir plate was used and set at 1000 RPM. The reaction was monitored by ¹H NMR spectroscopy at 16 h, 24 h, 51 h, 62 h, and 144 h. The reaction was stopped after 144 h. 5.56 g of pale yellow liquid was collected. Analysis by ¹H NMR spectroscopy revealed 93.5% aldehyde conversion with 92.6% acid and 0.9% formyl ester.

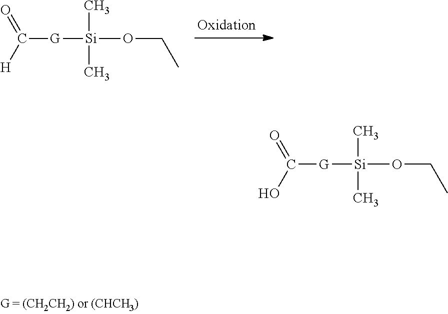

In this Working Example 14, RT oxidation of Aldehyde-siloxane 4, M^{Pr-Ald}D₇M^{Pr-Ald} (the hydroformylation product of Vinylsiloxane 4 M^{vi}D₇M^{vi}) prepared according to Synthesis Example 7 was performed as follows. A 40 mL vial was charged with a magnetic stirrer and M^{Pr-Ald}D₇M^{Pr-Ald} (10.1 g, 13.2 mmol). Air was bubbled, subsurface at 40 cc/min. The reaction was conducted at RT, and a stir plate was used and set at 1000 RPM. The reaction was monitored by ¹H NMR spectroscopy at 30 min, 1 h, 2 h, 4 h, 7 h, and 23 h. The reaction was stopped after 23 h. 9.35 g of a colorless liquid was obtained. Analysis by ¹H NMR spectroscopy revealed 96.5% aldehyde conversion with 87.0% acid and 6.1% formyl ester.

In this Working Example 15, 60° C. oxidation of Aldehyde-siloxane 4, M^{Pr-Ald}D₇M^{Pr-Ald} (the hydroformylation product of Vinylsiloxane 4 M^{vi}D₇M^{vi}) prepared according to Synthesis Example 7 was performed as follows. A 40 mL vial was charged with a magnetic stirrer and M^{Pr-Ald}D₇M^{Pr-Ald} (9.99 g, 13.1 mmol). Air was bubbled, subsurface at 40 cc/min. The reaction was conducted at 60° C., and a stir plate was used and set at 1000 RPM. The reaction was monitored by ¹H NMR spectroscopy at 30 min, 1 h, 2 h, 4 h, 7 h, and 23 h. The reaction was stopped after 23 h. 9.12 g of a colorless liquid was obtained. Analysis by ¹H NMR spectroscopy revealed 98.3% aldehyde conversion with 84.7% acid and 10.2% formyl ester.

In this Working Example 16, 100° C. oxidation of Aldehyde-siloxane 4, M^{Pr-Ald}D₇M^{Pr-Ald} (the hydroformylation product of Vinylsiloxane 4 M^{vi}D₇M^{vi}) prepared according to Synthesis Example 7 was performed as follows. A 40 mL vial was charged with a magnetic stirrer and M^{Pr-Ald}D₇M^{Pr-Ald} (10.1 g, 13.2 mmol). Air was bubbled, subsurface at 40 cc/min. The reaction was conducted at 100° C., and a stir plate was used and set at 1000 RPM. The reaction was monitored by ¹H NMR spectroscopy at 30 min, 1 h, 2 h, 4 h, 7 h, and 23 h. The reaction was stopped after 23 h. 8.55 g of a colorless liquid was obtained. Analysis by ¹H NMR spectroscopy revealed 98.4% aldehyde conversion with 80.0% acid and 16.0% formyl ester. Working Examples 14 to 16 showed that the oxidation reaction could be conducted at different temperatures.

In this Working Example 17, 0° C. oxidation of Aldehyde-siloxane 4, M^{Pr-Ald}D₇M^{Pr-Ald} a (the hydroformylation product of Vinylsiloxane 4 M^{vi}D₇M^{vi}) prepared according to Synthesis Example 7 was performed as follows. A 250 mL jacketed glass reactor was charged with M^{Pr-Ald}D₇M^{Pr-Ald} (91.1 g, 119 mmol). Air was bubbled, subsurface at 100 cc/min. The reaction was conducted at 0° C. an overhead stirrer was used for agitation and was set to 500 RPM. The reaction was monitored by ¹H NMR spectroscopy at 20 h, 23 h, 44 h, 67 h, and 140 h. The reaction was stopped after 140 h. 78.6 g of a colorless liquid was obtained. Analysis by ¹H NMR spectroscopy revealed 92.3% aldehyde conversion with 88.7% acid and 2.5% formyl ester.

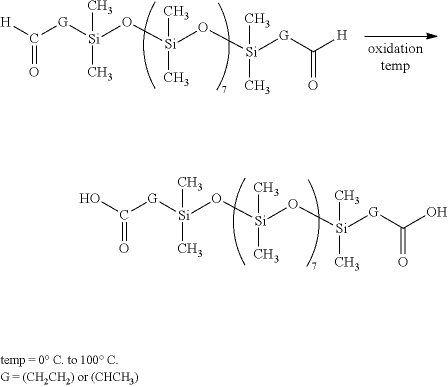

In this Working Example 18, oxidation of aldehyde-functional silane (hydroformylation product prepared according to Synthesis Example 16) was performed as follows. To a 40 mL septa cap vial equipped with a PTFE coated magnetic stir bar was loaded with 5.7 g of propyl-aldehyde functional trimethylsilane from synthesis example 16. Air was bubbled into the solution subsurface at a rate of 5 cc/min at a temperature of 22° C. while stirred with a magnetic stir plate at 1400 RPM. The reaction was continued for 22 hours and 5.8 g of liquid product was collected. ¹H NMR analysis of the product revealed 97.6% conversion with 91.2% acid and 6.4% formyl ester.

In this Working Example 19, oxidation of Aldehyde-siloxane 7, M^{Pr-Ald}D₃₂₉M^{Pr-Ald} (the hydroformylation product of Vinylsiloxane 7, M^{vi}₂D₃₂₉) prepared according to Synthesis Example 10 was performed as follows.

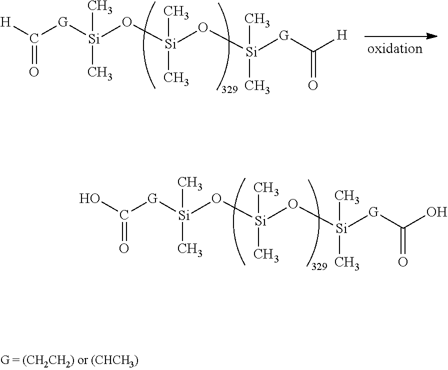

Crude M^{Pr-Ald}D₃₂₉M^{Pr-Ald} solution (1315 g) was loaded to a 2 L 3-neck glass flask with mechanical overhead stirring and a temperature controlled heating mantle. The reaction was run with ˜200 cc/min air added with two subsurface needles. The reaction temperature was controlled at 30° C. and the reaction was stirred at 400 RPM. The reaction was run for 115 hours. ¹H NMR analysis of the product revealed 96.4% conversion with 91.6% acid and 4.8% formyl ester.

In this Working Example 20, the M^{acid}-D₇-M^{acid} prepared according to Working Example 4 was equilibrated with D4 in the presence of trifluoromethanesulfonic acid to generate a terminal carboxy-functionalized PDMS as follows. To a 40 mL septa cap vial equipped with a PTFE coated stir bar was added M^{acid}-D₇-M^{acid} (3.3 g) and D4 (7.95 g) to form a homogeneous solution. The mixture was heated to 90° C. A solution of 1 wt % triflic acid in dichloromethane (100 uL) was added vial syringe. The mixture was stirred at 90° C. for 16 h with a headspace nitrogen purge (50 cc/min). The product was analyzed by NMR and GPC. Si NMR showed a DP of 42.

In this Working Example 21, the MD^{pr-acid}M prepared according to Working Example 1 was equilibrated with D4 in the presence of trifluoromethanesulfonic acid to generate a pendant carboxy-functionalized PDMS as follows. To a 40 mL septa cap vial equipped with a PTFE coated stir bar was added MD^{Pr-acid}M (0.95 g) and D4 (9.5 g) to form a homogeneous solution. The mixture was heated to 90° C. and the vial was purged with nitrogen. A solution of 1 wt % triflic acid in dichloromethane (100 uL) was added vial syringe. The mixture was stirred at 90° C. with a headspace nitrogen purge for 17 hours. At 25 hours reaction time, the nitrogen purge was removed and replaced with a static nitrogen headspace pad. The reaction was stopped at 113 hours. The product was analyzed by NMR and GPC. Si NMR showed a DP of 57.

In this Working Example 22, the MD_{8.2} D^{Pr-Acid}_{3.7}M prepared according to Working Example 2 was equilibrated with D4 in the presence of trifluoromethanesulfonic acid to generate a pendant carboxy functionalized PDMS as follows. To a 40 mL septa cap vial equipped with a PTFE coated stir bar was added MD_{8.2} D^{Pr-Acid}_{3.7}M (0.8 g) and D4 (12 g) to form a cloudy mixture. The mixture was heated to 90° C. and was cloudy. A solution of 1 wt % triflic acid in dichloromethane (120 uL) was added vial syringe. After 3 minutes the mixture became clear. The mixture was stirred at 90° C. with a headspace nitrogen pad for 15 hours. The product was analyzed by NMR and GPC. Si NMR showed a DP of 290.

In this Working Example 23, the MD_{8.2} D^{Pr-Acid}_{3.7}M prepared according to Working Example 2 and M^{acid}-D₇-M^{acid} prepared according to Working Example 4 were equilibrated with D4 in the presence of trifluoromethanesulfonic acid to generate a PDMS functionalized with pendant and terminal carboxy groups as follows. To a 40 mL septa cap vial equipped with a PTFE coated stir bar was added MD_{8.2} D^{Pr-Acid}_{3.7}M (1.1 g), M^{acid}-D₇-M^{acid} (0.73 g), and D4 (16 g) to form a mixture. The mixture was heated to 90° C. and a solution of 1 wt % triflic acid in dichloromethane (150 uL) was added vial syringe. The mixture was stirred at 90° C. with a headspace nitrogen purge for 19 hours. 0.53 g of material was collected from the headspace purge. The product was analyzed by NMR and GPC. Si NMR showed a DP of 160.

In this Working Example 24, oxidation of Aldehyde-siloxane 9, M^{Pr-Ald}D₇₇M^{Pr-Ald} (the hydroformylation product of Vinylsiloxane 16, M^{Vi}₂D₇₇) prepared according to Synthesis Example 12 was performed as follows.

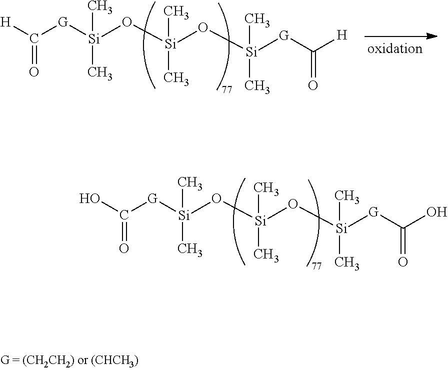

Crude M^{Pr-Ald}D₇₇M^{Pr-Ald} solution (185 g) was loaded to a 250 mL European style tapered wall flask with mechanical overhead stirring. The reaction was run with 50-100 cc/min air at ambient temperature 20-25° C. The oxidation was run for 68 hrs. ¹H NMR analysis of the product revealed 96.9% conversion with 87.5% acid and 9.3% formyl ester. The end of reaction mixture contained 1.5 wt % toluene. 139.17 g of yellow liquid was collected.

In this Working Example 25, oxidation of (M2T)3T Heptanaldehyde (prepared as described in Synthesis Example 14 was performed as follows. Crude (M2T)3T Heptanealdehyde (100 g) which contained approximately 5 wt % toluene was loaded to a one-neck round bottom flask equipped with a PTFE coated stir bar and a septa cap. The liquid was stirred on a magnetic stir plate at 1150 rpm as plant air was sparged subsurface through a needle. The reaction mixture was analyzed by 1H NMR until complete. The reaction was stopped after 24 hours and the (M2T)3T-Heptanoic acid product was collected as a clear orange liquid.

In this Working Example 26, oxidation of Aldehyde-siloxane 8, M^{Pr-Ald}D₂₅M^{Pr-Ald} (the hydroformylation product of Vinylsiloxane 8, M^{Vi}₂D₂₅) prepared according to Synthesis Example 11 was performed as follows.

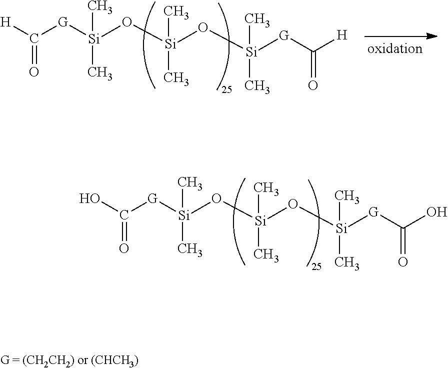

Crude M^{Pr-Ald}D₂₅M^{Pr-Ald} solution (572 g) containing approximately 3 wt % toluene was loaded to a 500 mL European style tapered wall flask with mechanical overhead stirring. The reaction was run with 200 cc/min air at ambient temperature starting at 22° C. The oxidation was run for 72 hrs. ¹H NMR analysis of the product revealed 98.4% conversion with 91.2% acid and 7.2% formyl ester. 550.7 g of clear slightly colored liquid was collected.

In this Working Example 27, RT oxidation of Aldehyde-siloxane 4, M^{Pr-Ald}D₇M^{Pr-Ald} a (the hydroformylation product of Vinylsiloxane 4 M^{vi}D₇M^{vi}) prepared according to Synthesis Example 7 in the presence of 285 nm UV light was performed as follows. A 20 mL quartz test tube was charged with M^{Pr-Ald}D₇M^{Pr-Ald} (5.00 g, 6.5 mmol). Air was bubbled, subsurface at 20 cc/min. The reaction was conducted at RT and was not stirred. A 285 nm UV LED was used to irradiate the sample for a specified time. The reaction was monitored by ¹H NMR spectroscopy at 15 min, 1 h, 3 h, 5 h, 8 h, and 13 h. The reaction was stopped after 13 h. 3.84 g of a colorless liquid was obtained. Analysis by ¹H NMR spectroscopy revealed 97.1% aldehyde conversion with 90.3% acid and 4.5% formyl ester. The reaction was repeated in the absence of UV light using the same amount of M^{Pr-Ald}D₇M^{Pr-Ald} (5.00 g, 6.5 mmol) and the same air bubbling rate (20 cc/min). After 13 h under these conditions ¹H NMR spectroscopy revealed 64.2% aldehyde conversion with 60.6% acid and 3.0% formyl ester. ¹H NMR spectroscopy revealed 97.1% aldehyde conversion with 90.3% acid and 4.5% formyl ester.

The reaction described above was repeated except without UV irradiation. After 13 h under these conditions, ¹H NMR spectroscopy revealed 64.2% aldehyde conversion with 60.6% acid and 3.0% formyl ester, showing that the reaction was still performed, but at a slower rate.

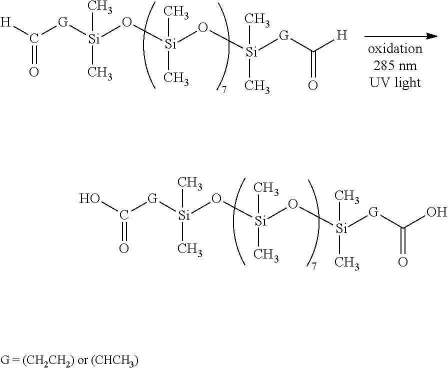

In this Working Example 28, RT oxidation of Aldehyde-siloxane 4, M^{Pr-Ald}D₇M^{Pr-Ald} (the hydroformylation product of Vinylsiloxane 4 M^{vi}D₇M^{vi}) prepared according to Synthesis Example 7 in the presence of a peroxy acid (3-chloroperbenzoic acid, oxidant 1) was performed as follows. A 40 mL vial was charged with a magnetic stirrer and M^{Pr-Ald}D₇M^{Pr-Ald} (2.22 g, 2.9 mmol). A separate 40 mL vial was charged with 3-chloroperbenzoic acid (1.22 g, 7.13 mmol) and deuterated benzene (2.58 g) to form a white slurry. The slurry was added to the vial containing M^{Pr-Ald}D₇M^{Pr-Ald} over 2 min. An aliquot from the reaction was analyzed by ¹H NMR spectroscopy after 15 min. Analysis by ¹H NMR spectroscopy revealed 87.9% aldehyde conversion with 58.8% acid and 29.1% formyl ester.

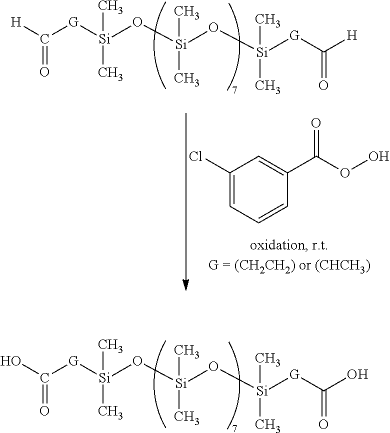

In this Working Example 29, 100° C. oxidation of Aldehyde-siloxane 4, M^{Pr-Ald}D₇M^{Pr-Ald} (the hydroformylation product of Vinylsiloxane 4 M^{vi}D₇M^{vi}) prepared according to Synthesis Example 7 in the presence of a organic peroxide (di-tert-butyl peroxide, oxidant 2) was performed as follows. A 40 mL vial was charged with a magnetic stirrer and M^{Pr-Ald}D₇M^{Pr-Ald}(0.95 g, 1.2 mmol) and tert-butyl peroxide (0.50 mL, 0.40 g, 2.72 mmol). The reaction was stirred under N₂ atmosphere and heated at 100° C. Aliquots were removed after 15 min, 1.5 h, and 3 h and analyzed by ¹H NMR spectroscopy to determine the molar ratio between the desired acid and the starting material. A control experiment was performed using M^{Pr-Ald}D₇M^{Pr-Ald} (0.95 g, 1.2 mmol) with no added oxidant and heating at 100° C. under N₂. Aliquots of this reaction were acquired after 15 min, 1.5 h, and 3 h and analyzed by ¹H NMR spectroscopy to determine the molar ratio between the desired acid and the starting material. The results from these experiments are presented in Table 4. After 3 h, the reaction was stopped. 0.72 g of a colorless liquid was obtained.

TABLE 4
Oxidation of M^{Pr-Ald}D₇M^{Pr-Ald}
using tert-butyl peroxide at 100° C.

| | | Molar ratio (mmol acid/mmol |
|---|---|---|
| Oxidant | Time | starting material) |
| Di-tert-butyl peroxide | 0 min | 0 |
| | 15 min | 0 |
| | 1.5 h | 0.04 |
| | 3 h | 0.31 |
| None (control) | 0 min | 0 |
| | 15 min | 0 |
| | 1.5 h | 0.01 |
| | 3 h | 0.01 |

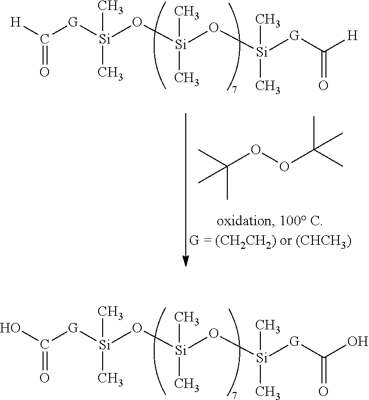

In this Working Example 30, 100° C. oxidation of Aldehyde-siloxane 4, M^{Pr-Ald}D₇M^{Pr-Ald} (the hydroformylation product of Vinylsiloxane 4 M^{vi}D₇M^{vi}) prepared according to Synthesis Example 7 in the presence of a organic hydroperoxide (tert-butyl hydroperoxide, oxidant 3) was performed as follows. A 40 mL vial was charged with a magnetic stirrer and M^{Pr-Ald}D₇M^{Pr-Ald} a (0.95 g, 1.2 mmol) and tert-butyl hydroperoxide (0.50 mL, 5.5 mmol/mL, 2.75 mmol). The reaction was stirred under N₂ atmosphere and heated at 100° C. Aliquots were removed after 15 min, 1.5 h, and 3 h and analyzed by ¹H NMR spectroscopy to determine the molar ratio between the desired acid and the starting material. A control experiment was performed using M^{Pr-Ald}D₇M^{Pr-Ald} (0.95 g, 1.2 mmol) with no added oxidant and heating at 100° C. under N₂. Aliquots of this reaction were acquired after 15 min, 1.5 h, and 3 h and analyzed by ¹H NMR spectroscopy to determine the molar ratio between the desired acid and the starting material. The results from these experiments are presented in Table 5. After 3 h, the reaction was stopped. 0.73 g of a colorless liquid was obtained.

TABLE 5
Oxidation of M^{Pr-Ald}D₇M^{Pr-Ald}
using tert-butyl hydroperoxide at 100° C.

| | | Molar ratio (mmol acid/mmol |
|---|---|---|
| Oxidant | Time | starting material) |
| Tert-butyl hydroperoxide | 0 min | 0 |
| | 15 min | 0.51 |
| | 1.5 h | 1.91 |
| | 3 h | 4.83 |
| None (control) | 0 min | 0 |
| | 15 min | 0 |
| | 1.5 h | 0.01 |
| | 3 h | 0.01 |

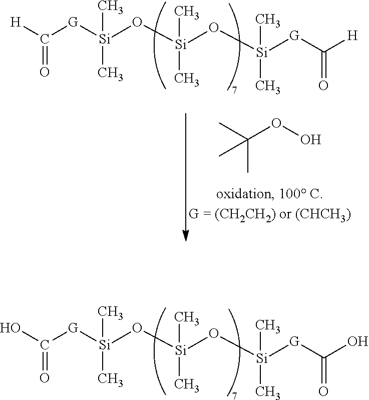

### INDUSTRIAL APPLICABILITY

The working examples above show that a variety of aldehyde-functional organosilicon compounds can successfully undergo oxidation reaction to form carboxy-functional organosilicon compounds using the process of this invention. The process described herein is flexible in that a wide variety of polymeric polyorganosiloxanes and organosilicon small molecules, with both pendant and/or terminal carboxy functionality) can be prepared. The process described herein is capable of forming carboxy-functional organosilicon compounds with two or more carboxy-groups per molecule. In addition, the process may have one or more of the following benefits: low cost, simple process, minimal by-product formation, relatively low pressure, low temperature of 50° C. or less (less likely to degrade sensitive molecules, lower capital cost, and safer), minimal side products, and good control of the reaction. Furthermore, the process does not require purification or separation of the starting materials before use.

### Definitions and Usage of Terms

All amounts, ratios, and percentages herein are by weight, unless otherwise indicated. The amounts of all starting materials in a composition total 100% by weight. The SUMMARY and ABSTRACT are hereby incorporated by reference. The articles ‘a’, ‘an’, and ‘the’ each refer to one or more, unless otherwise indicated by the context of specification. The singular includes the plural unless otherwise indicated. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The abbreviations used herein have the definitions in Table Z.

TABLE Z
Abbreviations

| Abbreviation | Definitions |
|---|---|
| acac | acetyl acetonate |
| ° C. | degrees Celsius |
| cc | cubic centimeters |
| D | Difunctional siloxy unit, trimethylsiloxy unit of |
| | formula Me₂SiO_{2/2} |
| D^{al} | Difunctional siloxy unit, allylmethylsiloxy unit of |
| | formula (Allyl)(Me)SiO_{2/2} |
| D^{hex} | Difunctional siloxy unit, hexenylmethylsiloxy unit |
| | of formula (Hex)(Me)SiO_{2/2} |
| D^{Pr-ald} | Difunctional siloxy unit, propylaldehyde, |
| | methylsiloxy unit of formula (Pr-ald)(Me)SiO_{2/2} |
| D^{vi} | Difunctional siloxy unit, vinylmethylsiloxy unit of |
| | formula (Vi)(Me)SiO_{2/2} |
| DP | degree of polymerization |
| DSC | Dow Silicones Corporation of Midland, Michigan, |
| | USA |
| Et | ethyl |
| FTIR | Fourier transform infra-red |
| g | gram |
| GPC | gel permeation chromatography |
| h or hr | hour |
| Hex | hexenyl |
| iPr | isopropyl |
| kPa | kiloPascals |
| M | Monofunctional siloxy unit, trimethylsiloxy unit of |
| | formula R₃SiO_{1/2} or Me₃SiO_{1/2} |
| M^{al} | Monofunctional siloxy unit, allyldimethylsiloxy |
| | unit of formula (Allyl)(Me₂)SiO_{1/2} |
| M^{hex} | Monofunctional siloxy unit, hexenyldimethylsiloxy |
| | unit of formula (Hex)(Me₂)SiO_{1/2} |
| M^{Pr-ald} | Monofunctional siloxy unit, propyladehyde, |
| | dimethylsiloxy unit of formula (Pr-ald)(Me₂)SiO_{1/2} |
| M^{vi} | Monofunctional siloxy unit, vinyldimethylsiloxy |
| | unit of formula (Vi)(Me₂)SiO_{1/2} |
| Me | methyl |
| mg | milligram |
| min | minute |
| mL | milliliter |
| mm | millimeter |
| Mmol | millimole |
| Mn | number average molecular weight measured by GPC |
| Mw | weight average molecular weight measured by GPC |
| mPa · s | milliPascal seconds |
| NBD | norbornadiene |
| NMR | nuclear magnetic resonance |
| PDI | Polydispersity index (calculated as Mw/Mn) |
| PDMS | polydimethylsiloxane |
| Ph | phenyl |
| ppm | parts per million by weight |
| Pr | propyl |
| Pr-ald | propyl-aldehyde |
| psi | pounds per square inch |
| PTFE | polytetrafluoroethylene |
| Q | tetrafunctional siloxy unit of formula SiO_{4/2} |
| RPM or rpm | revolutions per minute |
| RT | room temperature of 25 ± 5° C. |
| TDCC | The Dow Chemical Company of Midland, Michigan, |
| | USA |
| THF | tetrahydrofuran |
| μ or u | micro |
| μm | micrometer |
| Vi | vinyl |

The following test methods were used herein. FTIR: The concentration of silanol groups present in the polyorganosiloxane resins (e.g., polyorganosilicate resins and/or silsesquioxane resins) was determined using FTIR spectroscopy according to ASTM Standard E-168-16. GPC: The molecular weight distribution of the polyorganosiloxanes was determined by GPC using an Agilent Technologies 1260 Infinity chromatograph and toluene as a solvent. The instrument was equipped with three columns, a PL gel 5 μm 7.5×50 mm guard column and two Plgel 5 μm Mixed-C 7.5×300 mm columns. Calibration was made using polystyrene standards. Samples were made by dissolving polyorganosiloxanes in toluene (˜1 mg/mL) and then immediately analyzing the solution by GPC (1 m/min flow, 35° C. column temperature, 25-minute run time). ²⁹Si NMR: Alkenyl content of starting material (B) can be measured by the technique described in “The Analytical Chemistry of Silicones” ed. A. Lee Smith, Vol. 112 in Chemical Analysis, John Wiley & Sons, Inc. (1991). Viscosity: Viscosity may be measured at 25° C. at 0.1 to 50 RPM on a Brookfield DV-III cone & plate viscometer with #CP-52 spindle, e.g., for polymers (such as certain (B2) alkenyl-functional polyorganosiloxanes) with viscosity of 120 mPa·s to 250,000 mPa·s. One skilled in the art would recognize that as viscosity increases, rotation rate decreases and would be able to select appropriate spindle and rotation rate.

### EMBODIMENTS OF THE INVENTION

In a first embodiment, a process for preparing a carboxy-functional organosilicon compound comprises:
1) combining, under conditions to conduct hydroformylation reaction, starting materials comprising
   (A) a gas comprising hydrogen and carbon monoxide,
   (B) an alkenyl-functional organosilicon compound, and
   (C) a rhodium/bisphosphite ligand complex catalyst, where the bisphosphite ligand has formula

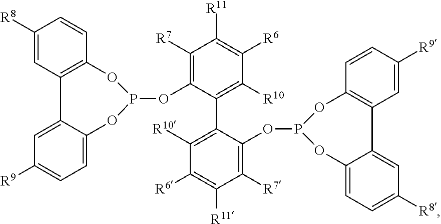

where
   R⁶ and R^{6′} are each independently selected from the group consisting of hydrogen, an alkyl group of 1 to 20 carbon atoms, a cyano group, a halogen group, and an alkoxy group of 1 to 20 carbon atoms;
   R⁷ and R^{7′} are each independently selected from the group consisting of an alkyl group of 3 to 20 carbon atoms, and a group of formula —SiR¹⁷₃, where each R¹⁷ is an independently selected monovalent hydrocarbon group of 1 to 20 carbon atoms;
   R⁸, R^{8′}, R^{9,} and R^{9′} are each independently selected from the group consisting of hydrogen, an alkyl group, a cyano group, a halogen group, and an alkoxy group, and
   R¹⁰ R^{10′}, R¹¹, and R^{11′} are each independently selected from the group consisting of hydrogen or and alkyl group; thereby forming a hydroformylation reaction product comprising an aldehyde-functional organosilicon compound; and
2) combining, under conditions to conduct oxidation reaction, starting materials comprising (E) the aldehyde-functional organosilicon compound and (F) an oxygen source, thereby forming an oxidation reaction product comprising (I) the carboxy-functional organosilicon compound.

In a second embodiment, in the process of the first embodiment, starting material (B) comprises an alkenyl-functional silane of formula (B1): R^{A}ₓSiR⁴₍₄₋ₓ₎, where each R^{A} is an independently selected alkenyl group of 2 to 8 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

In a third embodiment, in the process of the first embodiment, the alkenyl-functional organosilicon compound comprises an alkenyl-functional polyorganosiloxane of unit formula: (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(SiO_{4/2})_{g}(ZO_{1/2})ₕ; where each R^{A} is an independently selected alkenyl group of 2 to 8 carbon atoms, and each R⁴ is independently selected from the group consisting of an alkyl group of 1 to 18 carbon atoms, an aryl group of 6 to 18 carbon atoms, and an hydrocarbonoxy group of 1 to 18 carbon atoms; each Z is independently selected from the group consisting of a hydrogen atom and R⁵, where each R⁵ is independently selected from the group consisting of alkyl groups of 1 to 18 carbon atoms and aryl groups of 6 to 18 carbon atoms; subscripts a, b, c, d, e, f, and g represent numbers of each unit in formula (B2-1) and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, with the proviso that when e=f=g=0, then h≥0; 10,000≥(a+b+c+d+e+f+g)≥2, and a quantity (b+d+f)≥1.

In a fourth embodiment, in the process of the third embodiment, the alkenyl-functional polyorganosiloxane is cyclic and has a unit formula selected from the group consisting of: (R⁴R^{A}SiO_{2/2})_{d}, where subscript d is 3 to 12; (R⁴₂SiO_{2/2})_{c}(R⁴R^{A}SiO_{2/2})_{d}, where c is >0 to 6 and d is 3 to 12; and a combination thereof.

In a fifth embodiment, in the process of the third embodiment, the alkenyl-functional polyorganosiloxane is linear and comprises unit formula (B3): (R⁴₃SiO_{1/2})ₐ(R⁴₂R^{A}SiO_{1/2})_{b}(R⁴₂SiO_{2/2})_{c}(R⁴R^{A}SiO_{2/2})_{d}, where a quantity (a+b)=2, a quantity (b+d)≥1, and a quantity (a+b+c+d)≥2.

In a sixth embodiment, in the process of the third embodiment, the alkenyl-functional polyorganosiloxane is an alkenyl-functional polyorganosilicate resin comprising unit formula: (R⁴₃SiO_{1/2})ₘₘ(R⁴₂R^{A}SiO_{1/2})ₙₙ(SiO_{4/2})ₒₒ(ZO_{1/2})ₕ, where subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4.

In a seventh embodiment, in the process of the third embodiment, the alkenyl-functional polyorganosiloxane is an alkenyl-functional silsesquioxane resin comprising unit formula: (R⁴₃SiO_{1/2})ₐ(R⁴₂R^{A}SiO_{1/2})_{b}(R⁴₂SiO_{2/2})_{c}(R⁴R^{A}SiO_{2/2})_{d}(R⁴SiO_{3/2})ₑ(R^{A}SiO_{3/2})_{f}(ZO_{1/2})ₕ; where f>1, 2<(e+f)<10,000; 0<(a+b)/(e+f)<3; 0<(c+d)/(e+f)<3; and 0<h/(e+f)<1.5.

In an eighth embodiment, in the process of the third embodiment, the alkenyl-functional polyorganosiloxane is a branched oligomer comprising general formula: R^{A}SiR¹²₃, where R^{A} is as described above and each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100.

In a ninth embodiment, in the process of the third embodiment, the alkenyl-functional polyorganosiloxane comprises a Q branched polyorganosiloxane of unit formula (B2-13): (R⁴₃SiO_{1/2})_{q}(R⁴₂R^{A}SiO_{1/2})ᵣ(R⁴₂SiO_{2/2})ₛ(SiO_{4/2})ₜ, where subscripts q, r, s, and t have average values such that 2≥q≥0, 4≥r≥0, 995≥s≥4, t=1, (q+r)=4, and (q+r+s+t) has a value sufficient to impart a viscosity>170 mPa·s measured by rotational viscometry (as described below with the test methods) to the branched polyorganosiloxane.

In a tenth embodiment, in the process of the third embodiment, the alkenyl-functional polyorganosiloxane comprises a T branched polyorganosiloxane (silsesquioxane) of unit formula (B2-15): (R⁴₃SiO_{1/2})ₐₐ(R^{A}R⁴₂SiO_{1/2})_{bb}(R⁴₂SiO_{2/2})_{cc}(R^{A}R⁴SiO_{2/2})ₑₑ(R⁴SiO_{3/2})_{dd}, where subscript aa≥0, subscript bb>0, subscript cc is 15 to 995, subscript dd>0, and subscript ee≥0.

In an eleventh embodiment, in any one of the third to tenth embodiments, each R^{A} is independently selected from the group consisting of vinyl, allyl, and hexenyl.

In a twelfth embodiment, in the process of any one of the third to eleventh embodiments, each R⁴ is independently selected from the group consisting of methyl and phenyl.

In a thirteenth embodiment, the process of the first embodiment further comprises: II) equilibrating the carboxy-functional organosilicon compound with a cyclic polydiorganosiloxane in the presence of an equilibration catalyst.

In a fourteenth embodiment, in the process of any one of the first to thirteenth embodiments, in the bisphosphite ligand, R⁶ and R^{6′} are each selected from the group consisting of a methoxy group and a t-butyl group, R⁷ and R^{7′} are each a t-butyl group, and R⁸, R^{8′}, R^{9,} R^{9′}, R¹⁰ R^{10′}, R¹¹, and R^{11′} are each hydrogen.

In a fifteenth embodiment, in the process of any one of the first to fourteenth embodiments, starting material (C) is present in an amount sufficient to provide 0.1 ppm to 300 ppm Rh based on combined weights of starting materials (A), (B), and (C).

In a sixteenth embodiment, in the process of any one of the first to fifteenth embodiments, starting material (C) has a molar ratio of bisphosphite ligand/Rh of 1/1 to 10/1.

In a seventeenth embodiment, in the process of any one of the first to sixteenth embodiments, the conditions in step 2) are selected from the group consisting of: i) a temperature of 20° C. to 50° C.; ii) a pressure of 3 psia to 100 psia; iii) the oxygen source has 21% to 100% oxygen; and iv) a combination of two or more of conditions i), ii) and iii).

In an eighteenth embodiment, in the process of any one of the first to seventeenth embodiments, (C) the rhodium/bisphosphite ligand complex catalyst is formed by combining a rhodium precursor and the bisphosphite ligand to form a rhodium/bisphosphite ligand complex and combining the rhodium/bisphosphite ligand complex and starting material (A) with heating before step 1).

In a nineteenth embodiment, the aldehyde-functional organosilicon compound prepared by the process of the first embodiment or the second embodiment is an aldehyde-functional silane of formula (E1): R^{Ald}ₓSiR⁴₍₄₋ₓ₎, where each R^{Ald} is an independently selected aldehyde group of 3 to 9 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

In a twentieth embodiment, the aldehyde-functional organosilicon compound prepared by the process of the first embodiment or the second embodiment is an aldehyde-functional polyorganosiloxane of unit formula (E2-1): (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(SiO_{4/2})_{g}(ZO_{1/2})ₕ; where each R^{Ald} is an independently selected aldehyde group of 3 to 9 carbon atoms, and each R⁴ is independently selected from the group consisting of an alkyl group of 1 to 18 carbon atoms, an aryl group of 6 to 18 carbon atoms, and an hydrocarbonoxy group of 1 to 18 carbon atoms; each Z is independently selected from the group consisting of a hydrogen atom and R⁵, where each R⁵ is independently selected from the group consisting of alkyl groups of 1 to 18 carbon atoms and aryl groups of 6 to 18 carbon atoms; subscripts a, b, c, d, e, f, and g represent numbers of each unit in formula (E2-1) and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, with the proviso that when e=f=g=0, then h≥0, 10,000≥(a+b+c+d+e+f+g)≥2, and a quantity (b+d+f) 1.

In a twenty-first embodiment, in the process of the twentieth embodiment, the aldehyde-functional polyorganosiloxane is cyclic and has a unit formula selected from the group consisting of: (R⁴R^{Ald}SiO_{2/2})_{d}, where subscript d is 3 to 12; (R⁴₂SiO_{2/2})_{c}(R⁴R^{Ald}SiO_{2/2})_{d}, where c is >0 to 6 and d is 3 to 12; and a combination thereof.

In a twenty-second embodiment, in the process of the twentieth embodiment, the aldehyde-functional polyorganosiloxane is linear and comprises unit formula (E3): (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}, where a quantity (a+b)=2, a quantity (b+d)≥1, and a quantity (a+b+c+d)≥2.

In a twenty-third embodiment, in the process of the twentieth embodiment, the aldehyde-functional polyorganosiloxane is an aldehyde-functional polyorganosilicate resin comprising unit formula: (R⁴₃SiO_{1/2})ₘₘ(R⁴₂R^{Ald}SiO_{1/2})ₙₙ(SiO_{4/2})ₒₒ(ZO_{1/2})ₕ, where subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4.

In a twenty-fourth embodiment, in the process of the twentieth embodiment, the aldehyde-functional polyorganosiloxane is an aldehyde-functional silsesquioxane resin comprising unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})ₑ(R^{Ald}SiO_{3/2})_{f}(ZO_{1/2})ₕ; where f>1, 2<(e+f)<10,000; 0<(a+b)/(e+f)<3; 0<(c+d)/(e+f)<3; and 0<h/(e+f)<1.5.

In a twenty-fifth embodiment, in the process of the twentieth embodiment, the aldehyde-functional polyorganosiloxane is branched and comprises unit formula: R^{Ald}SiR¹²₃, where each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤5 ii≤100, with the proviso that at least two of R¹² are —OSi(R¹⁴)₃.

In a twenty-sixth embodiment, in the process of the twentieth embodiment, the aldehyde-functional polyorganosiloxane is a Q branched aldehyde-functional polyorganosiloxane oligomer comprising unit formula: (R⁴₃SiO_{1/2})_{q}(R⁴₂R^{Ald}SiO_{1/2})ᵣ(R⁴₂SiO_{2/2})ₛ(SiO_{4/2})ₜ, where subscripts q, r, s, and t have average values such that 2≥q≥0, 4≥r≥0, 995≥s≥4, t=1, (q+r)=4, and (q+r+s+t) has a value sufficient to impart a viscosity>170 mPa·s measured by rotational viscometry (as described below with the test methods) to the Q branched polyorganosiloxane; and

In a twenty-seventh embodiment, in the process of the twentieth embodiment, the aldehyde-functional polyorganosiloxane is a T branched aldehyde-functional polyorganosiloxane comprising unit formula: (R⁴₃SiO_{1/2})ₐₐ(R^{Ald}R⁴₂SiO_{1/2})_{bb}(R⁴₂SiO_{2/2})_{cc}(R^{Ald}R⁴SiO_{2/2})ₑₑ(R⁴SiO_{3/2})_{dd}, where subscript aa≥0, subscript bb>0, subscript cc is 15 to 995, subscript dd>0, and subscript ee≥0.

In a twenty-eighth embodiment, in the process of any one of the twentieth to twenty-seventh embodiments, each R^{Ald} is independently selected from the group consisting of propyl aldehyde, butyl aldehyde, and heptyl aldehyde.

In a twenty-ninth embodiment, in the process of any one of the twentieth to twenty-eighth embodiments, each R⁴ is independently selected from the group consisting of methyl and phenyl.

In a thirtieth embodiment, the process of any one of the first to twenty-ninth embodiments further comprises recovering the aldehyde-functional organosilicon compound before step 2).

In a thirty-first embodiment, in step 2) of the process of any one of the first to thirtieth embodiments an oxidation reaction catalyst is added.

In a thirty-second embodiment, in the process of the thirty-first embodiment, the oxidation reaction catalyst comprises a transition metal complex.

In a thirty-third embodiment, in the process of the thirty-second embodiment, the transition metal complex comprises a transition metal selected from the group consisting of Co, Cu, Ni, Mn, and Rh.

In a thirty-fourth embodiment, in the process of the thirty-first embodiment, the oxidation reaction catalyst is an organocatalyst containing N-hydroxy functionality.

In a thirty-fifth embodiment, in the process of the thirty-fourth embodiment, the organocatalyst is selected from the group consisting of N-hydroxyphthalimide and 2,2,6,6-Tetramethylpiperidin-1-yl)oxyl.

In a thirty-sixth embodiment, the process of any one of the first to thirty-fifth embodiments, further comprises 3) recovering the carboxy-functional organosilicon compound from the oxidation reaction product after step 2).

In a thirty-seventh embodiment, in the process of the second embodiment, the carboxy-functional organosilicon compound comprises a carboxy-functional silane of formula: R^{Car}ₓSiR⁴₍₄₋ₓ₎, where each R^{Car} is an independently selected carboxy group of 3 to 9 carbon atoms of formula

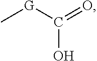

where G is a divalent hydrocarbon group free of aliphatic unsaturation that has 2 to 8 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

In a thirty-eighth embodiment, in the process of the third embodiment, the carboxy-functional organosilicon compound comprises a carboxy-functional polyorganosiloxane of unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(SiO_{4/2})_{g}(ZO_{1/2})ₕ; where each R^{Car} is an independently selected carboxy group of 3 to 9 carbon atoms of formula

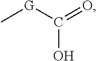

where G is a divalent hydrocarbon group free of aliphatic unsaturation that has 2 to 8 carbon atoms; each R⁴ is independently selected from the group consisting of an alkyl group of 1 to 18 carbon atoms, an aryl group of 6 to 18 carbon atoms, and an hydrocarbonoxy group of 1 to 18 carbon atoms; each Z is independently selected from the group consisting of a hydrogen atom and R⁵, where each R⁵ is independently selected from the group consisting of alkyl groups of 1 to 18 carbon atoms and aryl groups of 6 to 18 carbon atoms; subscripts a, b, c, d, e, f, and g represent numbers of each unit in the unit formula and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, with the proviso that when e=f=g=0, then h≥0,10,000≥(a+b+c+d+e+f+g)≥2, and a quantity (b+d+f)≥1.

In a thirty-ninth embodiment, in the process of the thirty-eighth embodiment, the carboxy-functional polyorganosiloxane is cyclic and has a unit formula selected from the group consisting of (R⁴R^{Car}SiO_{2/2})_{d}, where subscript d is 3 to 12; (R⁴₂SiO_{2/2})_{c}(R⁴R^{Car}SiO_{2/2})_{d}, where subscript c is >0 to 6 and subscript d is 3 to 12.

In a fortieth embodiment, in the process of the thirty-eighth embodiment, the carboxy-functional polyorganosiloxane is linear and comprises unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}, where a quantity (a+b)=2, a quantity (b+d)≥1, and a quantity (a+b+c+d)≥2.

In a forty-first embodiment, in the process of the thirty-eighth embodiment, the carboxy-functional polyorganosiloxane is a carboxy-functional polyorganosilicate resin comprising unit formula: (R⁴₃SiO_{1/2})ₘₘ(R⁴₂R^{Car}SiO_{1/2})ₙₙ(SiO_{4/2})ₒₒ(ZO_{1/2})ₕ, where subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4.

In a forty-second embodiment, in the process of the thirty-eighth embodiment, the carboxy-functional polyorganosiloxane is a carboxy-functional silsesquioxane resin comprising unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(ZO_{1/2})ₕ; where f>1, 2<(e+f)<10,000; 0<(a+b)/(e+f)<3; 0<(c+d)/(e+f)<3; and 0<h/(e+f)<1.5.

In a forty-third embodiment, in the process of the thirty-eighth embodiment, where the carboxy-functional polyorganosiloxane is branched.

In a forty-fourth embodiment, in the process of any one of the thirty-seventh embodiment to the forty-third embodiment, each R^{Car} is independently selected from the group consisting of —(C₂H₄)C(═O)OH, —(C₃H₆)C(═O)OH, and —(C₆H₁₂)C(═O)OH.

In a forty-fifth embodiment, in the process of any one of the thirty-seventh embodiment to the forty-fourth embodiment, where each R⁴ is independently selected from the group consisting of methyl and phenyl.

In a forty-sixth embodiment, in the process of any one of the preceding embodiments, the oxidation reaction is conducted at a temperature of 0 to 100° C.

In a forty-seventh embodiment, in the process of any one of the preceding embodiments, the starting materials are exposed to ultra-violet radiation during the oxidation reaction in step 2).

1. A process for preparing a carboxy-functional organosilicon compound, the process comprising:
forming an aldehyde-functional organosilicon compound before step I) by a process comprising combining, under conditions to catalyze hydroformylation reaction, starting materials comprising,
(A) a gas comprising hydrogen and carbon monoxide,
(B) an alkenyl-functional organosilicon compound, and
(C) a rhodium/bisphosphite ligand complex catalyst, where the bisphosphite ligand has formula 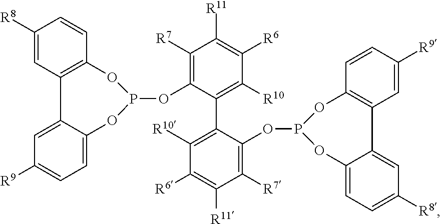
where
R⁶ and R^{6′} are each independently selected from the group consisting of hydrogen, an alkyl group of 1 to 20 carbon atoms, a cyano group, a halogen group, and an alkoxy group of 1 to 20 carbon atoms;
R⁷ and R^{7′} are each independently selected from the group consisting of an alkyl group of 3 to 20 carbon atoms, and a group of formula —SiR¹⁷₃, where each R¹⁷ is an independently selected monovalent hydrocarbon group of 1 to 20 carbon atoms;
R⁸, R^{8′}, R^{9,} and R^{9′} are each independently selected form the group consisting of hydrogen, an alkyl group, a cyano group, a halogen group, and an alkoxy group, and
R^{10′}, R¹¹, and R¹¹′ are each independently selected from the group consisting of hydrogen or and alkyl group; thereby forming a hydroformylation reaction product comprising the aldehyde-functional organosilicon compound; and thereafter
I) combining, under conditions to conduct oxidation reaction, starting materials comprising the aldehyde-functional organosilicon compound and an oxygen source, thereby forming an oxidation reaction product comprising the carboxy-functional organosilicon compound.

2. The process of claim 1, where the aldehyde-functional organosilicon compound comprises an aldehyde-functional silane of formula: R^{Ald}ₓSiR⁴₍₄₋ₓ₎, where each R^{Ald} is an independently selected aldehyde group of 3 to 9 carbon atom having formula 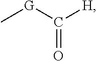
where G is a linear or branched divalent hydrocarbon group of 2 to 8 carbon atoms that is free of aliphatic unsaturation; each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

3. The process of claim 1, where the aldehyde-functional organosilicon compound comprises an aldehyde-functional polyorganosiloxane of unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})_{c}(R^{Ald}SiO_{3/2})_{f}(SiO_{4/2})_{g}(ZO_{1/2})ₕ; where each R^{Ald} is an independently selected aldehyde group of 3 to 9 carbon atoms, and each R⁴ is independently selected from the group consisting of an alkyl group of 1 to 18 carbon atoms, an aryl group of 6 to 18 carbon atoms, and an hydrocarbonoxy group of 1 to 18 carbon atoms; each Z is independently selected from the group consisting of a hydrogen atom and R⁵, where each R⁵ is independently selected from the group consisting of alkyl groups of 1 to 18 carbon atoms and aryl groups of 6 to 18 carbon atoms; subscripts a, b, c, d, e, f, and g represent numbers of each unit in the unit formula and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, with the proviso that when e=f=g=0, then h≥0; 10,000≥(a+b+c+d+e+f+g)≥2, and a quantity (b+d+f)≥1.

4. The process of claim 3, where the aldehyde-functional polyorganosiloxane is selected from the group consisting of:
i) a cyclic aldehyde-functional polyorganosiloxane having a unit formula selected from the group consisting of (R⁴R^{Ald}SiO_{2/2})_{d}, where subscript d is 3 to 12; (R⁴₂SiO_{2/2})_{c}(R⁴R^{Ald}SiO_{2/2})_{d}, where c is >0 to 6 and d is 3 to 12; and a combination thereof;
ii) a linear aldehyde-functional polyorganosiloxane comprising unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}, where a quantity (a+b)=2, a quantity (b+d)≥1, and a quantity (a+b+c+d)≥2;
iii) an aldehyde-functional polyorganosilicate resin comprising unit formula: (R⁴₃SiO_{1/2})ₘₘ(R⁴₂R^{Ald}SiO_{1/2})ₙₙ(SiO_{4/2})ₒₒ(ZO_{1/2})ₕ, where subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4;
iv) an aldehyde-functional silsesquioxane resin comprising unit formula: (R⁴₃SiO_{1/2})ₐ(R⁴₂R^{Ald}SiO_{1/2})_{b}(R⁴₂SiO_{2/2})_{c}(R⁴R^{Ald}SiO_{2/2})_{d}(R⁴SiO_{3/2})_{c}(R^{Ald}SiO_{3/2})_{f}(ZO_{1/2})ₕ; where f>1, 2<(e+f)<10,000; 0<(a+b)/(e+f)<3; 0<(c+d)/(e+f)<3; and 0<h/(e+f)<1.5;
v) a branched aldehyde-functional polyorganosiloxane comprising unit formula: R^{Ald}SiR¹²₃, where each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100, with the proviso that at least two of R¹² are —OSi(R¹⁴)_{3;}
vi) a Q branched aldehyde-functional polyorganosiloxane oligomer comprising unit formula: (R⁴₃SiO_{1/2})_{q}(R⁴₂R^{Ald}SiO_{1/2})ᵣ(R⁴₂SiO_{2/2})ₛ(SiO_{4/2})ₜ, where subscripts q, r, s, and t have average values such that 2≥q≥0, 4≥r≥0, 995≥s≥4, t=1, (q+r)=4, and (q+r+s+t) has a value sufficient to impart a viscosity>170 mPa·s measured by rotational viscometry (as described below with the test methods) to the Q branched polyorganosiloxane; and
vii) a T branched aldehyde-functional polyorganosiloxane comprising unit formula: (R⁴₃SiO_{1/2})ₐₐ(R^{Ald}R⁴₂SiO_{1/2})_{bb}(R⁴₂SiO_{2/2})_{cc}(R^{Ald}R⁴SiO_{2/2})ₑₑ(R⁴SiO_{3/2})_{dd}, where subscript aa≥0, subscript bb>0, subscript cc is 15 to 995, subscript dd>0, and subscript ee≥0.

5. The process of claim 2, where each R^{Ald} is independently selected from the group consisting of propyl aldehyde, butyl aldehyde, and heptyl aldehyde.

6. The process of a claim 2, where each R⁴ is independently selected from the group consisting of methyl and phenyl.

7. The process of claim 1, further comprising: II) equilibrating the carboxy-functional organosilicon compound with a cyclic polydiorganosiloxane in the presence of an equilibration catalyst.

8. The process of claim 1, further comprising
recovering the aldehyde-functional organosilicon compound before step I).

9. The process of claim 1, were the oxygen source is selected from the group consisting of air, oxygen gas, and a peroxide compound.

10. The process of claim 9, where the oxygen source is used at a partial pressure from 3 psia (20 kPa) to 100 psia (690 kPa).

11. The process of claim 1, where the starting materials in step I) further comprise an additional material selected from the group consisting of an oxidation reaction catalyst, a solvent, and both the oxidation reaction catalyst and the solvent.

12. The process of claim 11, where the oxidation reaction catalyst is present and comprises a transition metal complex comprising a metal selected from the group consisting of Co, Cu, Mn, Ni, Rh, and a combination of two or more thereof.

13. The process of claim 11, where the oxidation reaction catalyst is present and comprises an organocatalyst comprising N-hydroxy functionality.

14. The process of claim 11, where the oxidation reaction catalyst is present in an amount of 0.001 to 1 mole % based on moles of aldehyde-functional groups from the aldehyde-functional organosilicon compound.

15. The process of claim 11, where the solvent is present and is selected from the group consisting of a ketone, an ester, a carboxylic acid, an aliphatic hydrocarbon, an aromatic hydrocarbon, and a combination of two or more thereof.

16. The process of claim 2, where the carboxy-functional organosilicon compound comprises a carboxy-functional silane of formula: R^{Car}ₓSiR⁴₍₄₋ₓ₎, where each R^{Car} is an independently selected carboxy-functional group of 3 to 9 carbon atoms; each R⁴ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

17. The process of claim 3, where the carboxy-functional organosilicon compound comprises a carboxy-functional polyorganosiloxane of unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(SiO_{4/2})_{g} (ZO_{1/2})ₕ; where each R^{Car} is an independently selected carboxy-functional group of 3 to 9 carbon atoms, and each R⁴ is independently selected from the group consisting of an alkyl group of 1 to 18 carbon atoms, an aryl group of 6 to 18 carbon atoms, and an hydrocarbonoxy group of 1 to 18 carbon atoms; each Z is independently selected from the group consisting of a hydrogen atom and R⁵, where each R⁵ is independently selected from the group consisting of alkyl groups of 1 to 18 carbon atoms and aryl groups of 6 to 18 carbon atoms; subscripts a, b, c, d, e, f, and g represent numbers of each unit in the unit formula and have values such that subscript a≥0, subscript b≥0, subscript c≥0, subscript d≥0, subscript e≥0, subscript f≥0, subscript g≥0; and subscript h has a value such that 0≤h/(e+f+g)≤1.5, with the proviso that when e=f=g=0, then h≥0, 10,000≥(a+b+c+d+e+f+g)≥2, and a quantity (b+d+f)≥1.

18. The process of claim 17, where the carboxy-functional polyorganosiloxane is selected from the group consisting of:
i) a cyclic carboxy-functional polyorganosiloxane having a unit formula selected from the group consisting of (R⁴R^{Car}SiO_{2/2})_{d}, where subscript d is 3 to 12; (R⁴₂SiO_{2/2})_{c}(R⁴R^{Car}SiO_{2/2})_{d}, where c is >0 to 6 and d is 3 to 12;
ii) a linear carboxy-functional polyorganosiloxane comprising unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}, where a quantity (a+b)=2, a quantity (b+d)≥1, and a quantity (a+b+c+d)≥2;
iii) a carboxy-functional polyorganosilicate resin comprising unit formula: (R⁴₃SiO_{1/2})ₘₘ(R⁴₂R^{Car}SiO_{1/2})ₙₙ(SiO_{4/2})ₒₒ(ZO_{1/2})ₕ, where subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4;
iv) a carboxy-functional silsesquioxane resin comprising unit formula: (R⁴₃SiO_{1/2})ₐ(R⁴₂R^{Car}SiO_{1/2})_{b}(R⁴₂SiO_{2/2})_{c}(R⁴R^{Car}SiO_{2/2})_{d}(R⁴SiO_{3/2})ₑ(R^{Car}SiO_{3/2})_{f}(ZO_{1/2})ₕ; where f>1, 2<(e+f)<10,000; 0<(a+b)/(e+f)<3; 0<(c+d)/(e+f)<3; and 0<h/(e+f)<1.5; and
a branched carboxy-functional polyorganosiloxane comprising unit formula: R^{Car}SiR¹²₃, where each R¹² is selected from R¹³ and —OSi(R¹⁴)₃; where each R¹³ is a monovalent hydrocarbon group; where each R¹⁴ is selected from R¹³, —OSi(R¹⁵)₃, and —[OSiR¹³₂]ᵢᵢOSiR¹³₃; where each R¹⁵ is selected from R¹³, —OSi(R¹⁶)₃, and —[OSiR¹³₂]ᵢᵢOSiR¹³₃; where each R¹⁶ is selected from R¹³ and —[OSiR¹³₂]ᵢᵢOSiR¹³₃; and where subscript ii has a value such that 0≤ii≤100, with the proviso that at least two of R¹² are —OSi(R¹⁴)₃;
v) a Q branched carboxy-functional polyorganosiloxane oligomer comprising unit formula: (R⁴₃SiO_{1/2})_{q}(R⁴₂R^{Car}SiO_{1/2})ᵣ(R⁴₂SiO_{2/2})ₛ(SiO_{4/2})ₜ, where subscripts q, r, s, and t have average values such that 2≥q≥0, 4≥r≥0, 995≥s≥4, t=1, (q+r)=4, and (q+r+s+t) has a value sufficient to impart a viscosity>170 mPa·s measured by rotational viscometry (as described below with the test methods) to the Q branched polyorganosiloxane; and
vi) a T branched carboxy-functional polyorganosiloxane comprising unit formula: (R⁴₃SiO_{1/2})ₐₐ(R^{Car}R⁴₂SiO_{1/2})_{bb}(R⁴₂SiO_{2/2})_{cc}(R^{Car}R⁴SiO_{2/2})ₑₑ(R⁴SiO_{3/2})_{dd}, where subscript aa≥0, subscript bb>0, subscript cc is 15 to 995, subscript dd>0, and subscript ee≥0.

19. The process of claim 1, where step I) is conducted at a temperature of 0 to 100° C.

20. The process of claim 1, where step I) is conducted in the presence of UV radiation.
